(19) United States
(12) Patent Application Publication
(10) Pub. No.: US 2025/0361405 A1
(43) Pub. Date: Nov. 27, 2025

(54) COMPOSITION BASED ON A POLYMERIZABLE COMPONENT AND A THIXOTROPIC ADDITIVE

(71) Applicant: Arkema France, Colombes (FR)

(72) Inventors: Orlane BOUZARD, Verneuil En Halatte (FR); Vincent LEROY, Verneuil En Halatte (FR); Gaelle MELLOT, Verneuil En Halatte (FR); Thierry SOULA, Verneuil En Halatte (FR)

(21) Appl. No.: 18/872,486

(22) PCT Filed: Jun. 7, 2023
(86) PCT No.: PCT/EP2023/065206

§ 371 Date: Dec. 6, 2024

(30) Foreign Application Priority Data
Jun. 8, 2022 (FR) FR2205511

(51) Int. Cl. C09D 4/06; C08F 220/14; C08F 220/28; C08F 222/10; C08F 222/22; C09D 7/63; C09D 133/12; C09D 133/14; C09D 135/02

(52) U.S. Cl. CPC C09D 4/06; C08F 220/14; C08F 220/282; C08F 222/102; C08F 222/22; C09D 7/63; C09D 133/12; C09D 133/14; C09D 135/02

(57) ABSTRACT

The present invention relates to a composition based on a polymerizable component and on a thixotropic additive and also to a two-component system containing said composition and to a process for preparing a crosslinked product from said composition. The invention also relates to the use of an additive for increasing the viscosity and/or imparting thixotropic properties to a polymerizable component.

### TECHNICAL FIELD

The present invention relates to a composition based on a polymerizable component and on a thixotropic additive and also to a two-component system containing said composition and to a process for preparing a crosslinked product from said composition. The invention also relates to the use of an additive for increasing the viscosity and/or imparting thixotropic properties to a polymerizable component.

### PRIOR ART

Compositions based on (meth)acrylate-functionalized compounds widely used it many fields, such as coatings, adhesives and composite materials. Increasing the viscosity of a composition based on a (meth)acrylate-functionalized compound using a rheology additive advantageously makes it possible to facilitate the storage, handling and use of these compositions. Furthermore, the phenomenon of sedimentation of the fillers in a composition based on (meth)acrylate-functionalized compounds leads to inhomogeneities in the properties of the material which results therefrom; it is advisable to provide anti-sedimentation properties to limit this phenomenon.

However, the use of compositions based on (meth)acrylate-functionalized compounds requires particular precautions since these compounds, notably (meth)acrylate-functionalized monomers, may have a high saturation vapour pressure and evaporate easily. This results in a change in the concentration of the composition and requires specific equipment to be installed for trapping the vapours released.

Technologies exist for rheology additives, notably for fatty acid diamides and silicas, which are suitable for solving this problem but which require activation by heating and/or high shear which gives rise to self-heating.

Rheology modifiers based on diurea-diurethane are a good alternative to these rheology additives since they are liquid and do not require high-temperature activation steps. Thus, they can be incorporated easily and directly into the composition to be thickened at ambient temperature (20-25° C.).

Patent application EP 3 381 961 A1 describes moulding compositions prepared from a composition of monomers comprising a thixotropic additive based on diurea-diurethane.

However, the thixotropic additive described in this application contains salts such as lithium chloride or a surfactant. Lithium salts can cause problems of corrosion when the composition is applied to metal substrates and can generate uncontrolled species due to its Lewis acidity. Furthermore, lithium salts, in particular LiCl, are toxic compounds and the formulations which contain them are subject to the regulations in force as regards classification, labelling and packaging of chemicals.

There is therefore a need for new compositions based on (meth)acrylate-functionalized compounds and on a thixotropic agent comprising a diurea-diurethane compound that contain neither salt nor surfactant. Said thixotropic additive is stable, easily prepared without a step of distillation of residual diisocyanate and has a rheological performance that is at least equivalent, or even better, than comparable additives from the prior art.

After numerous research studies, the applicant has developed a composition which meets this need.

### SUMMARY OF THE INVENTION

The invention relates to a composition comprising:
a) a polymerizable component comprising a (meth)acrylate-functionalized compound;
b) a thixotropic additive comprising a diurea-diurethane compound;
component b) containing less than 0.1 mol of salt per urea group in component b).

The invention also relates to a two-component system comprising:
a first cartridge comprising a radical initiator;
a second cartridge comprising the composition according to the invention and optionally an activator of the radical initiator;
the first cartridge being held separate from the second cartridge.

The invention also relates to a process for preparing a crosslinked product comprising the following steps:
mixing the composition according to the invention with a radical initiator and optionally an activator of the radical initiator;
applying the mixture obtained on a substrate.

The invention also relates to the use of an additive comprising a diurea-diurethane compound and containing less than 0.1 mol of salt per urea group in the additive for increasing the viscosity and/or imparting thixotropic properties to a polymerizable component comprising a (meth)acrylate-functionalized compound.

### DETAILED DESCRIPTION

### Definitions

In the present patent application, the terms “comprises a” and “comprises an” mean “comprises one or more”.

Unless otherwise mentioned, the percentages by weight in a compound or a composition are expressed relative to the weight of the compound or of the composition.

The term “diurea-diurethane compound” means a compound having two urea functions and two urethane functions.

The term “diurethane compound” means a compound having two urethane functions and no urea function.

The term “polyurea-diurethane compound” means a compound having two urethane functions and at least four urea functions.

The term “urea function” or “urea group” means an —NH—C(═O)—NH—sequence. The term “urethane function” or “urethane group” means an —NH—C(═O)—O—or —O—C(═O)—NH—sequence.

The term “solvent” means a liquid having the property of dissolving, diluting or lowering the viscosity of other substances without chemically modifying them and without itself being modified.

The term “aprotic solvent” means a solvent which does not have an acidic hydrogen atom. In particular, an aprotic solvent does not comprise a hydrogen atom bonded to a heteroatom (O, N or S).

The term “salt” means an ionic compound. A salt can be inorganic or organic, preferably inorganic. Within the meaning of the present invention, the term “salt” does not include ionic surfactants.

The term “surfactant” means a compound capable of modifying the surface tension between two surfaces. A surfactant can in particular be an amphiphilic compound, that is to say that it has two parts of different polarity, the lipophilic part (which retains fatty substances) is non-polar and the other hydrophilic (water-miscible) part is polar.

The term “alkyl” means a saturated monovalent acyclic group of formula —CₙH₂ₙ₊₁. An alkyl can be linear or branched. A C₁-C₃₀ alkyl means an alkyl having from 1 to 30 carbon atoms.

The term “alkenyl” means a monovalent acyclic hydrocarbon group having one or more C═C double bonds. An alkenyl can be linear or branched. A C₂-C₃₀ alkenyl means an alkenyl having from 2 to 30 carbon atoms.

The term “cycloalkyl” means a monovalent cyclic hydrocarbon group. A cycloalkyl can be saturated or unsaturated. A cycloalkyl is non-aromatic. A C₅-C₁₂ cycloalkyl means a cycloalkyl having from 5 to 12 carbon atoms.

The term “aryl” means a monovalent aromatic hydrocarbon group. A C₆-C₁₂ aryl means an aryl having from 6 to 12 carbon atoms.

The term “arylalkyl” means an alkyl group substituted by an aryl group.

The term “aliphatic” means a non-aromatic acyclic compound or group. It can be linear or branched, saturated or unsaturated and substituted or unsubstituted. It can comprise one or more bonds/functions, for example chosen from ether, ester, amine and mixtures thereof.

The term “cycloaliphatic” means a non-aromatic compound or group comprising a ring having only carbon atoms as ring atoms. It can be substituted or unsubstituted.

The term “aromatic” means a compound or a group comprising an aromatic ring, that is to say obeying Hückel's rule of aromaticity, in particular a compound comprising a phenyl group. It can be substituted or unsubstituted. It can comprise one or more bonds/functions as defined for the term “aliphatic”.

The term “araliphatic” means a compound or a group comprising an aliphatic part and an aromatic part.

The term “heterocyclic” means a compound or a group comprising a ring having at least one heteroatom chosen from N, O and/or S as ring atom. It can be substituted or unsubstituted. It can be aromatic or non-aromatic.

Component a)-(Meth) Acrylate-Functionalized Compound

The composition according to the invention comprises a polymerizable component, also referred to as component a). Component a) may notably comprise all of the polymerizable compounds of the composition according to the invention. In particular, component a) may notably comprise all of the ethylenically unsaturated compounds of the composition according to the invention. These compounds may notably be intended to be polymerized, notably by radical polymerization reaction.

The purposes of the invention, an “ethylenically unsaturated compound” means a compound which comprises a polymerizable carbon-carbon double bond. A polymerizable carbon-carbon double bond is a carbon-carbon double bond that can react with another carbon-carbon double bond in a polymerization reaction. A polymerizable carbon-carbon double bond is generally within a group chosen from acrylate (including cyanoacrylate), methacrylate, acrylamide, methacrylamide, styrene, maleate, fumarate, itaconate, allyl, propenyl, vinyl and corresponding combinations, preferably chosen from acrylate, methacrylate and vinyl, more preferably chosen from acrylate and methacrylate. The carbon-carbon double bonds of a phenyl ring are not regarded as polymerizable carbon-carbon double bonds.

Component a) comprises a (meth)acrylate-functionalized compound. Component a) may comprise a mixture of (meth)acrylate-functionalized compounds.

As used here, the term “(meth)acrylate-functionalized compound” means a compound comprising at least one (meth)acryloyloxy group, in particular an acryloyloxy group. The term “(meth)acryloyloxy group” encompasses acryloyloxy (—O—CO—CH═CH₂) groups and methacryloyloxy (—O—CO—C(CH₃)═CH₂) groups.

The total amount of (meth)acrylate-functionalized compound in component a) may be from 20% to 100%, in particular from 30% to 100%, from 40% to 100%, from 50% to 100%, from 60% to 100%, from 70% to 100%, from 80% to 100%, from 90% to 100%, by weight on the basis of the weight of component a). According to one embodiment, component a) does not comprise polymerizable compounds other than (meth)acrylate-functionalized compounds.

Component a) may notably comprise a (meth)acrylate-functionalized compound chosen from a (meth)acrylate-functionalized monomer, a (meth)acrylate-functionalized oligomer, and mixtures thereof. In particular, component a) may comprise a (meth)acrylate-functionalized monomer and optionally a (meth)acrylate-functionalized oligomer.

Component a) may notably comprise a (meth)acrylate-functionalized monomer.

Component a) may comprise a mixture of (meth)acrylate-functionalized monomers

The (meth)acrylate-functionalized monomer may have a molecular weight of less than 600 g/mol, in particular from 70 to less than 550 g/mol, more particularly from 80 to 450 g/mol, more particularly from 90 to 350 g/mol.

The (meth)acrylate-functionalized monomer may have 1 to 6 (meth)acryloyloxy groups, in particular 1 to 4 (meth)acryloyloxy groups.

The (meth)acrylate-functionalized monomer may comprise a mixture of (meth)acrylate-functionalized monomers having different functionalities. For example, the (meth)acrylate-functionalized monomer may comprise a mixture of a (meth)acrylate-functionalized monomer containing a single acryloyloxy or methacryloyloxy group power molecule (referred to here as “mono(meth)acrylate-functionalized monomer”) and of a (meth)acrylate-functionalized monomer containing 2 or more, preferably 2 to 6, acryloyloxy and/or methacryloyloxy groups per molecule (referred to here as “poly(meth)acrylate-functionalized monomer”).

Component a) may notably comprise a mono(meth)acrylate-functionalized monomer. Component a) may notably comprise a mixture of mono(meth)acrylate-functionalized monomers. A mono(meth)acrylate-functionalized monomer may advantageously function as a reactive diluent and reduce the viscosity of the composition according to the invention. Examples of suitable mono(meth)acrylate-functionalized monomers include, but are not limited to, (meth)acrylic acid, mono(meth)acrylic esters of aliphatic alcohols (it being possible for the alcohol to be straight chain or branched and to be a monoalcohol, a dialcohol or a polyalcohol, on condition that only one hydroxyl group is esterified by a (meth)acrylic acid); mono(meth)acrylic esters of cycloaliphatic or heterocyclic alcohols; mono(meth)acrylic esters of aromatic alcohols (such as phenols, including alkylated phenols); mono(meth)acrylic esters of alkylaryl alcohols (such as benzyl alcohol); mono(meth)acrylic esters of oligomeric and polymeric glycols (such as diethylene glycol, triethylene glycol, dipropylene glycol, tripropylene glycol, a polyethylene glycol, and a polypropylene glycol); mono(meth)acrylic esters of monoalkyl ethers of glycols and oligoglycols; caprolactone mono(meth)acrylates; and also the alkoxylated (e.g. ethoxylated and/or propoxylated) derivatives thereof; and the mixtures thereof.

Component a) may notably comprise a mono(meth)acrylate-functionalized monomer chosen from (meth)acrylic acid; methyl(meth)acrylate; ethyl(meth)acrylate; n-propyl(meth)acrylate; isopropyl(meth)acrylate; n-butyl(meth)acrylate; isobutyl(meth)acrylate; n-pentyl(meth)acrylate; n-hexyl(meth)acrylate; 2-ethylhexyl(meth)acrylate; n-octyl(meth)acrylate; isooctyl(meth)acrylate; n-decyl(meth)acrylate; isodecyl(meth)acrylate; n-dodecyl(meth)acrylate; tridecyl(meth)acrylate; tetradecyl(meth)acrylate; hexadecyl(meth)acrylate; 2-hydroxyethyl(meth)acrylate; 2-hydroxypropyl(meth)acrylate; 3-hydroxypropyl(meth)acrylate; 4-hydroxybutyl(meth)acrylate; 2-methoxyethyl(meth)acrylate; 2-ethoxyethyl(meth)acrylate; 2-ethoxypropyl(meth)acrylate; 3-ethoxypropyl(meth)acrylate; tetrahydrofurfuryl(meth)acrylate; 2-(2-ethoxyethoxy)ethyl(meth)acrylate; cyclohexyl(meth)acrylate; glycidyl(meth)acrylate; benzyl(meth)acrylate; 2-phenoxyethyl(meth)acrylate; phenol (meth)acrylate; nonylphenol (meth)acrylate; cyclic trimethylolpropane formal (meth)acrylate; isobornyl(meth)acrylate; tricyclodecane methanol (meth)acrylate; tert-butylcyclohexyl(meth)acrylate; trimethylcyclohexyl(meth)acrylate; diethylene glycol monomethyl ether (meth)acrylate; diethylene glycol monobutyl ether (meth)acrylate; triethylene glycol monoethyl ether (meth)acrylate; polyethylene glycol monomethyl ether (meth)acrylate; hydroxyl ethyl-butyl urethane (meth)acrylate; 3-(2-hydroxyalkyl) oxazolidinone (meth)acrylate; (2,2-dimethyl-1,3-dioxolan-4-yl)methyl(meth)acrylate; (2-ethyl-2-methyl-1,3-dioxolan-4-yl)methyl(meth)acrylate; 1,3-dioxan-5-yl(meth)acrylate; (1,3-dioxolan-4-yl)methyl(meth)acrylate; glycerol carbonate (meth)acrylate; and also the alkoxylated (e.g. ethoxylated and/or propoxylated) derivatives thereof; and the mixtures thereof.

In particular, component a) may notably comprise a mono(meth)acrylate-functionalized monomer chosen from (meth)acrylic acid; methyl(meth)acrylate; ethyl(meth)acrylate; n-propyl(meth)acrylate; isopropyl(meth)acrylate; n-butyl(meth)acrylate; isobutyl(meth)acrylate; n-pentyl(meth)acrylate; n-hexyl(meth)acrylate; 2-ethylhexyl(meth)acrylate; n-octyl(meth)acrylate; n-dodecyl(meth)acrylate; 2-hydroxyethyl(meth)acrylate; 2-hydroxypropyl(meth)acrylate; tetrahydrofurfuryl(meth)acrylate; cyclohexyl(meth)acrylate; trimethylcyclohexyl(meth)acrylate; glycidyl(meth)acrylate; benzyl(meth)acrylate; 2-phenoxyethyl(meth)acrylate; cyclic trimethylolpropane formal (meth)acrylate; isobornyl(meth)acrylate; (2,2-dimethyl-1,3-dioxolan-4-yl)methyl (meth)acrylate; (2-ethyl-2-methyl-1,3-dioxolan-4-yl)methyl(meth)acrylate; 1,3-dioxan-5-yl(meth)acrylate; (1,3-dioxolan-4-yl)methyl(meth)acrylate; and also the alkoxylated (e.g. ethoxylated and/or propoxylated) derivatives thereof; and the mixtures thereof.

More particularly, component a) may notably comprise methyl methacrylate optionally as a mixture with at least one other (meth)acrylate-functionalized compound. Component a) may notably comprise a poly(meth)acrylate-functionalized monomer. Examples of poly(meth)acrylate-functionalized monomers include acrylate and methacrylate esters of polyols (organic compounds containing two or more, e.g. 2 to 6, hydroxyl groups per molecule). Specific examples of suitable polyols are ethylene glycol, 1,2- or 1,3-propylene glycol, 1,2-, 1,3- or 1,4-butylene glycol, 1,5-pentanediol, 1,6-hexanediol, 1,8-octanediol, 1,9-nonanediol, 1,10-decanediol, 1,12-dodecanediol, 2-methyl-1,3-propanediol, 2,2-diethyl-1,3-propanediol, 3-methyl-1,5-pentanediol, 3,3-dimethyl-1,5-pentanediol, neopentyl glycol, 2,4-diethyl-1,5-pentanediol, cyclohexanediol, cyclohexane-1,4-dimethanol, norbornene dimethanol, norbornane dimethanol, tricyclodecanediol, tricyclodecane dimethanol, hydrogenated bisphenol A, B, F or S, hydrogenated bisphenol A, B, F or S, trimethylolmethane, trimethylolethane, trimethylolpropane, di(trimethylolpropane), triethylolpropane, pentaerythritol, di(pentaerythritol), glycerol, di-, tri-or tetraglycerol, polyglycerol, di-, tri- or tetraethylene glycol, di-, tri- or tetrapropylene glycol, di-, tri- or tetrabutylene glycol, a polyethylene glycol, a polypropylene glycol, a polytetramethylene glycol, a poly(ethylene glycol-co-propylene glycol), an alditol (i.e. erythritol, threitol, arabitol, xylitol, ribitol, mannitol, sorbitol, galactitol, fucitol or iditol), a dianhydrohexitol (i.e. isosorbide, isomannide or isoidide), tris(2-hydroxyethyl) isocyanurate, a polybutadiene polyol, and also the alkoxylated (e.g., ethoxylated and/or propoxylated) derivatives thereof and the derivatives obtained by ring-opening polymerization of a lactone (e.g. ε-caprolactone) initiated with one of the abovementioned polyols. Such polyols may be fully or partially esterified (with a (meth)acrylic acid, a (meth)acrylic anhydride, a (meth)acryloyl chloride or the like), provided that they contain at least two (meth)acryloyloxy functional groups per molecule.

In particular, component a) may notably comprise a poly(meth)acrylate-functionalized monomer chosen from bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-decanediol di(meth)acrylate 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; glycerol di(meth)acrylate; glycerol tri (meth)acrylate; trimethylolethane tri (meth)acrylate; trimethylolethane di(meth)acrylate; trimethylolpropane tri (meth)acrylate; trimethylolpropane di(meth)acrylate; pentaerythritol di(meth)acrylate; pentaerythritol tri (meth)acrylate, pentaerythritol tetra(meth)acrylate, di(trimethylolpropane) di(meth)acrylate;

di(trimethylolpropane) tri (meth)acrylate; di(trimethylolpropane) tetra(meth)acrylate;

sorbitol penta (meth)acrylate; di(pentaerythritol) tetra(meth)acrylate; di(pentaerythritol) penta (meth)acrylate; di(pentaerythritol) hexa (meth)acrylate; tris(2-hydroxyethyl) isocyanurate tri (meth)acrylate; and also the alkoxylated (e.g. ethoxylated and/or propoxylated) derivatives thereof; and the mixtures thereof.

More particularly, component a) may notably comprise a poly(meth)acrylate-functionalized monomer chosen from 1,6-hexanediol di(meth)acrylate; trimethylolpropane tri (meth)acrylate; pentaerythritol tetra(meth)acrylate; and mixtures thereof.

Component a) may comprise from 0% to 100%, in particular from 5% to 100%, from 10% to 100%, from 15% to 100%, from 20% to 95%, from 25% to 95%, from 30% to 95%, from 35% to 90%, from 40% to 90%, or from 50% to 90%, by weight of (meth)acrylate-functionalized monomer on the basis of the weight of component a). Component a) may comprise from 0% to 60%, from 5% to 60%, from 10% to 60%, from 15% to 60%, from 20% to 60%, from 25% to 60%, from 30% to 60%, from 35% to 60%, from 40% to 60% or from 45% to 60% by weight of (meth)acrylate-functionalized monomer on the basis of the weight of component a). As a variant, component a) may comprise from 60% to 100%, from 65% to 100%, from 70% to 100%, from 75% to 100%, from 80% to 100%, from 85% to 100%, from 90% to 100%, from 95% to 100%, by weight of (meth)acrylate-functionalized monomer on the basis of the weight of component a).

Component a) may notably comprise a (meth)acrylate-functionalized oligomer.

Component a) may comprise a mixture of (meth)acrylate-functionalized oligomers.

The (meth)acrylate-functionalized oligomer may be chosen in order to enhance the flexibility, strength and/or modulus, among other attributes, of a product obtained by polymerization of the composition according to the present invention.

The (meth)acrylate-functionalized oligomer may have 1 to 18 (meth)acryloyloxy groups, in particular 2 to 6 (meth)acryloyloxy groups, more particularly 2 to 6 acryloyloxy groups.

The (meth)acrylate-functionalized monomer may have a number-average molecular weight of greater than or equal to 600 g/mol, in particular 800 to 15000 g/mol, more particularly 1000 to 5000 g/mol.

In particular, component a) may notably comprise a (meth)acrylate-functionalized oligomer chosen from (meth)acrylate-functionalized urethane oligomers, (meth)acrylate-functionalized epoxy oligomers, (meth)acrylate-functionalized polyether oligomers, (meth)acrylate-functionalized polydiene oligomers, (meth)acrylate-functionalized polycarbonate oligomers, (meth)acrylate-functionalized polyester oligomers; (meth)acrylate-functionalized acrylic oligomers; and mixtures thereof.

(Meth)acrylate-functionalized urethane oligomers (sometimes also referred to as “polyurethane (meth)acrylate oligomers”) suitable for use in the polymerizable compositions of the present invention include urethanes based on at least one polyol, on at least one polyisocyanate and on at least one hydroxyl-functionalized and (meth)acrylate-functionalized compound (also known as hydroxyl-functionalized (meth)acrylate). (Meth)acrylate-functionalized urethane oligomers may be prepared by reacting a polyisocyanate (e.g. diisocyanate or triisocyanate, which is aliphatic, cycloaliphatic, heterocyclic or aromatic) with a polyol (notably a polyester polyol, a polyether polyol, a polycarbonate polyol, a polycaprolactone polyol, a polyorganosiloxane polyol, or a polydiene polyol such as a polybutadiene polyol, all corresponding combinations), to form isocyanate-terminated oligomers which are then reacted with a hydroxyl-functionalized (meth)acrylate (such as hydroxyethyl (meth)acrylate) to provide terminal (meth)acrylate groups. For example, the (meth)acrylate-functionalized urethane oligomers may contain two, three, four or more (meth)acrylate functional groups per molecule. Other orders of addition may also be used to prepare the (meth)acrylate-functionalized urethane oligomer.

For example, a hydroxyl-functionalized (meth)acrylate may be first reacted with a polyisocyanate to obtain an isocyanate-functionalized (meth)acrylate, which may then be reacted with a polyol. As a variant, all components may be combined and reacted at the same time.

Examples of suitable (meth)acrylate-functionalized epoxy oligomers include the reaction products of (meth)acrylic acid (or a corresponding synthetic equivalent, such as acid chloride, alkyl ester or anhydride) with an epoxy resin comprising at least one epoxide group (in particular at least one group chosen from glycidyl ether, glycidyl ester and combinations thereof). The epoxy resin may, in particular, be chosen from bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resin, hydrogenated bisphenol A diglycidyl ether, hydrogenated bisphenol F diglycidyl ether, hydrogenated bisphenol S diglycidyl ether, 3,4-epoxycyclohexylmethyl-3′,4′-epoxycyclohexanecarboxylate, 2-(3,4-epoxycyclohexyl-5,5-spiro-3,4-epoxy)cyclohexane-1,4-dioxane, bis(3,4-epoxycyclohexylmethyl) adipate, vinylcyclohexene oxide, 4-vinylepoxycyclohexane, bis(3,4-epoxy-6-methylcyclohexylmethyl) adipate, 3,4-epoxy-6-methylcyclohexyl-3′,4′-epoxy-6′-methylcyclohexanecarboxylate, methylenebis(3,4-epoxycyclohexane), dicyclopentadiene diepoxide, ethylene glycol di(3,4-epoxycyclohexylmethyl) ether, ethylenebis(3,4-epoxycyclohexanecarboxylate), 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, polyglycidyl ethers of a polyether polyol obtained by addition of one or more alkylene oxides to an aliphatic polyhydric alcohol, such as ethylene glycol, propylene glycol, and glycerol, diglycidyl esters of aliphatic long-chain dibasic acids, monoglycidyl ethers of aliphatic higher alcohols, monoglycidyl ethers of phenol, cresol, butylphenol, or polyether alcohols obtained by the addition of alkylene oxide to these compounds, glycidyl esters of higher fatty acids, epoxidized soybean oil, epoxybutylstearic acid, epoxyoctylstearic acid, epoxidized linseed oil, epoxidized polybutadiene, and the like.

Suitable (meth)acrylate-functionalized polyether oligomers include, but without being limited thereto, the reaction products of (meth)acrylic acid (or a corresponding synthetic equivalent, such as acid chloride, alkyl ester or anhydride) with at least one polyetherol which corresponds to a polyether polyol (such as a polyethylene glycol, a polypropylene glycol, a polytetramethylene glycol or a copolymer thereof). Suitable polyetherols may be linear or branched substances containing ether bonds and terminal hydroxyl groups. Polyetherols may be prepared by ring-opening polymerization of cyclic ethers such as tetrahydrofuran or alkylene oxides (e.g. ethylene oxide and/or propylene oxide) with a starting molecule. Suitable starting molecules include water, polyhydroxyl-functionalized materials, polyester polyols and amines.

(Meth)acrylate-functionalized polydiene oligomers given by way of example include the reaction products of (meth)acrylic acid (or a corresponding synthetic equivalent, such as acid chloride, alkyl ester or anhydride) with hydroxyl-terminated polydiene polyols, notably a hydroxyl-terminated polybutadiene polyol.

(Meth)acrylate-functionalized polycarbonate oligomers given by way of example include the reaction products of (meth)acrylic acid (or a corresponding synthetic equivalent, such as acid chloride, alkyl ester or anhydride) with hydroxyl-terminated polycarbonate polyols.

(Meth)acrylate-functionalized polydiene oligomers given by way of example include the reaction products of (meth)acrylic acid (or a corresponding synthetic equivalent, such as acid chloride, alkyl ester or anhydride) with hydroxyl-terminated polyester polyols. The reaction process can be carried out so that all, or essentially all, the hydroxyl groups of the polyester polyol have been (meth)acrylated, particularly in cases where the polyester polyol is difunctional. Polyester polyols may be prepared by polycondensation reactions of polyhydroxyl-functionalized components (in particular, diols) and poly(carboxylic acid)-functionalized compounds (in particular, dicarboxylic acids and anhydrides). The polyhydroxyl-functionalized and poly(carboxylic acid)-functionalized components may each have linear, branched, cycloaliphatic or aromatic structures and may be used individually or as mixtures.

Suitable (meth)acrylate-functionalized acrylic oligomers (sometimes also known in the prior art as “acrylic oligomers”) comprise oligomers which may be described as substances having an acrylic backbone which is functionalized with one or more (meth)acrylate groups (which may be at an end of the oligomer or pendent to the acrylic backbone). The acrylic backbone may be a homopolymer, a random copolymer or block copolymer composed of repeating units of acrylic-type monomers. The acrylic-type monomers may be any monomeric (meth)acrylate such as C₁-C₆ alkyl (meth)acrylates and also functionalized (meth)acrylates such as (meth)acrylates bearing hydroxyl, carboxylic acid and/or epoxy groups. Acrylic (meth)acrylate oligomers may be prepared using any procedure known in the prior art, such as oligomerization of monomers, at least one portion of which are functionalized with hydroxyl, carboxylic acid and/or epoxy groups (e.g., hydroxyalkyl (meth)acrylates, a (meth)acrylic acid, a glycidyl (meth)acrylate) to obtain a functionalized oligomer-type intermediate, which is then reacted with one or more (meth)acrylate-containing reactants in order to introduce the desired (meth)acrylate functional groups.

In particular, component a) may notably comprise a (meth)acrylate-functionalized oligomer chosen from (meth)acrylate-functionalized urethane oligomers, (meth)acrylate-functionalized polydiene oligomers, (meth)acrylate-functionalized acrylic oligomers; and mixtures thereof.

Component a) may comprise from 0% to 100%, in particular from 5% to 100%, from 10% to 100%, from 15% to 100%, from 20% to 95%, from 25% to 95%, from 30% to 95%, from 35% to 90%, from 40% to 90%, or from 50% to 90%, by weight of (meth)acrylate-functionalized oligomer on the basis of the weight of component a). Component a) may comprise from 0% to 60%, from 5% to 60%, from 10% to 60%, from 15% to 60%, from 20% to 60%, from 25% to 60%, from 30% to 60%, from 35% to 60%, from 40% to 60% or from 45% to 60% by weight of (meth)acrylate-functionalized oligomer on the basis of component a). As a variant, component a) may comprise from 60% to 100%, from 65% to 100%, from 70% to 100%, from 75% to 100%, from 80% to 100%, from 85% to 100%, from 90% to 100% or from 95% to 100% by weight of (meth)acrylate-functionalized oligomer on the basis of the weight of component a).

According to a particular embodiment, component a) comprises:
from 10% to 100%, from 20% to 100%, from 30% to 100%, from 40% to 95%, or from 50% to 90%, by weight of (meth)acrylate-functionalized monomer; and
from 0% to 90%, from 0% to 80%, from 0% to 70%, from 5% to 60%, or from 10% to 50%, by weight of (meth)acrylate-functionalized oligomer.
   Component b)-Thixotropic Additive

The composition according to the invention comprises a thixotropic additive, also referred to as component b). The thixotropic additive is notably used to increase the viscosity and/or to impart thixotropic properties to the composition according to the invention. For the purposes of the invention, the term “to impart thixotropic properties to a composition” means to increase the viscosity of a composition when the composition is at rest (no shear stress is applied) and to lower the viscosity of a composition when the composition is subjected to a shear stress in a reversible manner with memory of the history or time-dependent manner. The increase and decrease in the viscosity can be determined relative to a control composition that does not comprise any thixotropic additive.

Component b) comprises a diurea-diurethane compound. Component b) may comprise a mixture of polyurea-diurethane compounds. Component b) may further comprise an aprotic solvent.

Component b) is stable although it contains little or no salt. Component b) contains less than 0.1 mol of salt per urea group in component b) (excluding any aprotic solvent). The number of urea groups is determined relative to all the compounds contained in component b) (excluding any aprotic solvent). The diurea-diurethane compound(s) contain(s) 2 urea groups. If component b) contains 1 mol of diurea-diurethane compound(s) and if there is no other compound having at least one urea group in component b), then component b) contains less than 0.2 mol of salt.

In particular, component b) may contain from 0 to less than 0.1 mol, or from 0 to 0.09 mol, or from 0 to 0.07 mol, or from 0 to 0.05 mol, or from 0 to 0.03 mol, or from 0 to 0.01 mol, or from 0 to 0.001 mol, of salt per urea group in component b) (excluding any aprotic solvent).

More particularly, component b) may contain less than 1%, or from 0% to 0.9%, or from 0% to 0.7%, or from 0% to 0.5%, or from 0% to 0.25%, or from 0% to 0.2%, or from 0% to 0.15%, or from 0% to 0.09%, or from 0% to 0.03%, by weight of LiCl, relative to the weight of component b) (excluding any aprotic solvent).

More particularly, component b) may contain less than 1.6%, or from 0% to 1.4%, or from 0% to 1.1%, or from 0% to 0.8%, or from 0% to 0.4%, or from 0% to 0.3%, or from 0% to 0.25%, or from 0% to 0.15%, or from 0% to 0.05%, by weight of LiNO₃ relative to the weight of component b) (excluding any aprotic solvent).

The salt can in particular be chosen from a metal salt, an ionic liquid and an ammonium salt. In particular, the salt can be a metal salt chosen from a halide, an acetate, a formate or a nitrate. More particularly, the salt can be a lithium salt. More particularly still, the salt can be a lithium salt chosen from LiCl, LiNO₃, LiBr and their mixtures.

Component b) may in particular be stable without addition of stabilizer, such as, in particular, a surfactant. According to a specific embodiment, component b) according to the invention contains less than 0.1 mol of surfactant per urea group in component b).

In particular, component b) may contain from 0 to 0.1 mol, or from 0 to 0.08 mol, or from 0 to 0.06 mol, or from 0 to 0.04 mol, or from 0 to 0.02 mol, or from 0 to 0.01 mol, or from 0 to 0.001 mol, of surfactant per urea group in component b) (excluding any aprotic solvent).

More particularly, component b) may contain less than 3%, or from 0% to 2.8%, or from 0% to 2.4%, or from 0% to 2%, or from 0% to 1.6%, or from 0% to 1.2%, or from 0% to 1%, or from 0% to 0.5%, or from 0% to 0.1%, or from 0% to 0.01%, by weight of surfactant, relative to the weight of component b) (excluding any aprotic solvent).

The surfactant can in particular be chosen from an anionic surfactant, a cationic surfactant, a non-ionic surfactant, a zwitterionic surfactant and their mixtures. The surfactant can in particular have an HLB of from 8 to 12.

Examples of anionic surfactants are sulfonates, sulfates, sulfosuccinates, phosphates and carboxylates. Examples of cationic surfactants are quaternary ammonium salts (in particular tetraalkylammonium salts and quaternary ammonium esters or esterquats).

Examples of non-ionic surfactants are alkoxylated (in particular ethoxylated and/or propoxylated) fatty alcohols, alkyl glycosides, esters of fatty acids (in particular glycol esters, glycerol esters, sorbitan esters or sucrose esters of fatty acids) and esters of fatty acids which are alkoxylated (in particular ethoxylated and/or propoxylated). Examples of zwitterionic surfactants are betaines, imidazolines, sultaines, phospholipids and amine oxides.

Component b) may have an NCO index of less than 0.5 mg KOH/g, in particular of less than 0.2 mg KOH/g, more particularly of less than 0.1 mg KOH/g, more particularly still 0 mg KOH/g. The NCO index can be measured according to the method described below.

### Diurea-Diurethane Compound

Component b) comprises a diurea-diurethane compound. Component b) may comprise a mixture of diurea-diurethane compounds.

The diurea-diurethane compound may correspond to a compound of formula (I):

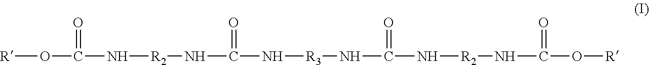

in which the R′, R₂ and R₃ groups are as defined below.

Preferably, the compounds of formula (I) do not contain a tertiary amine function or a quaternary ammonium function.

The compound(s) of formula (I) can in particular correspond to the reaction product(s) of at least one alcohol of formula R′—OH, of at least one diisocyanate of formula OCN—R₂—NCO and of at least one diamine of formula H₂N—R₃—NH₂.

Component b) may in particular comprise 5 to 80 mol %, in particular 15 to 75 mol %, more particularly 25 to 65 mol % of compound of formula (I) relative to the total molar amount of compounds having one or more functions chosen from urea, urethane and mixtures thereof (excluding any aprotic solvent).

### R′ Group

A compound of formula (1) contains two R′ groups. The R′ groups of one and the same compound of formula (I) can be identical or different. Component b) may comprise a mixture of compounds of formula (I) having identical R′ groups. Component b) may comprise a mixture of compounds of formula (I) which differ in their R′ groups. For example, some compounds of the mixture can have identical R′ groups and some compounds of the mixture can have different R′ groups.

Each R′ group can originate from the use of an alcohol of formula R′—OH to form the diurea-diurethane compound(s) of formula (I). The R′ group can correspond to the residue of an alcohol of formula R′—OH without the OH group. The R′ groups and the corresponding alcohols of formula R′—OH described below also apply to the process for preparing the diurea-diurethane compound described below.

Each R′ is independently chosen from alkyl, alkenyl, cycloalkyl, aryl, arylalkyl, •—[(CRₐR_{b})ₙ—O]ₘ—Y and •—[(CR_{c}(R_{d})ₚ—C(═O)O]_{q}—Z;

the symbol • represents a point of attachment to a urethane group of the formula (I); Y and Z are independently chosen from alkyl, alkenyl, cycloalkyl, aryl and arylalkyl; Rₐ, R_{b}, R_{c} and R_{d} are independently chosen from H and methyl, in particular H; each n is independently equal to 2, 3 or 4, in particular n is 2;

m ranges from 1 to 30, in particular m ranges from 2 to 25;

p ranges from 3 to 5, in particular p is 5;

q ranges from 1 to 20, in particular q ranges from 2 to 10.

An R′ group can be an alkyl, in particular a C₁ to C₃₀ alkyl. Examples of suitable alkyl groups are methyl, propyl, 1-methylethyl, butyl, X₁₋₂-methylpropyl, pentyl, X₁₋₃-methylbutyl, hexyl, X₁₋₄-methylpentyl, heptyl, X₁₋₅-methylhexyl, octyl, X₁₋₆-methylheptyl, 2-ethylhexyl, nonyl, X₁₋₇-methyloctyl, decyl, X₁₋₈-methylnonyl, undecyl, X₁₋₉-methyldecyl, dodecyl, X₁₋₁₀-methylundecyl, tridecyl, X₁₋₁₁-methyldodecyl, 2,5,9-trimethyldecyl, tetradecyl, X₁₋₁₂-methyltridecyl, pentadecyl, X₁₋₁₃-methyltetradecyl, hexadecyl, X₁₋₁₄-methylpentadecyl, heptadecyl, X₁₋₁₅-methylhexadecyl, octadecyl, X₁₋₁₆-methylheptadecyl, nonadecyl, X₁₋₁₇-methyloctadecyl, icosyl, X₁₋₁₈-methylnonadecyl, henicosyl, X₁₋₁₉-methylicosyl, docosyl, X₁₋₂₀-methylhenicosyl, 2-propylheptyl, 2-propylnonyl, 2-pentylnonyl, 2-butyloctyl, 2-butyldecyl, 2-hexyloctyl, 2-hexyldecyl, 2-octyldecyl, 2-hexyldodecyl, 2-octyldodecyl, 2-decyltetradecyl, 6-methyldodecyl and isomers thereof, in which X_{a-b} represents an integer which can take any value ranging from a to b, X_{a-b} indicating the position of the substituent in the alkyl group. The X₁₋₁₁-methyldodecyl group is a dodecyl group substituted by a methyl group in the 1, 2, 3, 4, 5, 6, 7, 8, 9, 10 or 11 position, for example 11-methyldodecyl or 2-methyldodecyl. The term “isomers” is understood to mean the alkyl groups comprising the same number of carbon atoms but having a different substitution scheme, for example an ethyl substituent instead of a methyl substituent or a greater number of methyl substituents. Thus, the 2,5,9-trimethyldecyl group is an isomer of the 11-methyldodecyl or 2-methyldodecyl group. The abovementioned alkyl groups can in particular be bonded to the urethane group in the 1 position. Thus, the 2,5,9-trimethyldecyl group can be represented by the following formula:

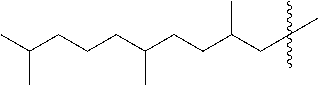 [SMILES: *CC(C)CCC(C)CCCC(C)C]

in which the broken line represents a point of attachment to a urethane group of the compound of formula (I).

An R′ group can be an alkenyl, in particular a C₂ to C₃₀ alkenyl. Examples of suitable alkenyl groups are hex-Y₂₋₅-enyl, hept-Y₂₋₆-enyl, oct-Y₂₋₇-enyl, non-Y₂₋₈-enyl, dec-Y₂₋₉-enyl, undec-Y₂₋₁₀-enyl, dodec-Y₂₋₁₁-enyl, tridec-Y₂₋₁₂-enyl, tetradec-Y₂₋₁₃-enyl, hexadec-Y₂₋₁₅-enyl, octadec-Y₂₋₁₇-enyl, icos-Y₂₋₁₉-enyl, docos-Y₂₋₂₁-enyl, heptadeca-8,11-dienyl, octadeca-9,12-dienyl, nonadeca-10,13-dienyl, icosa-11,14-dienyl, docosa-13,16-dienyl, octadeca-5,9,12-trienyl, octadeca-6,9,12-trienyl, octadeca-9,12,15-trienyl, octadeca-9,11,13-trienyl, icosa-8,11,14-trienyl and icosa-11,14,17-trienyl, in which Ya-b represents an integer which can take any value ranging from a to b, Ya-b indicating the position of the double bond in the alkenyl group. The hex-Y₂₋₅-enyl group is a hexenyl group in which the double bond can be in the 2, 3, 4 or 5 position, which corresponds to the hex-2-enyl, hex-3-enyl, hex-4-enyl and hex-5-enyl groups. The abovementioned alkenyl groups can in particular be bonded to the urethane group in the 1 position. Thus, the hex-2-enyl group can be represented by the following formula:

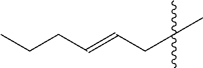 [SMILES: *C/C=C/CCC]

in which the broken line represents a point of attachment to a urethane group of the compound of formula (I).

An R′ group can be a cycloalkyl, in particular a C₅ to C₁₂ cycloalkyl. Examples of suitable cycloalkyl groups are cyclopentyl, cyclohexyl, cycloheptyl, cycloctyl, cyclononyl, cyclodecyl, cycloundecyl and cyclododecyl.

An R′ group can be an aryl, in particular a C₆ to C₁₂ aryl. Examples of suitable aryl groups are phenyl, naphthyl, biphenyl, ortho-, meta or para-tolyl, 2,3-, 2,4-, 2,5-, 2,6-, 3,4- or 3,5-xylyl and mesityl.

An R′ group can be an arylalkyl, in particular a C₇ to C₁₂ arylalkyl. Examples of suitable arylalkyl groups are benzyl, 2-phenylethyl, 3-phenylpropyl, 4-phenylbutyl and 2-phenylbutyl.

An R′ group can be a •—[(CRₐR_{b})ₙ—O]ₘ—Y group in which:
Y is chosen from alkyl, alkenyl, cycloalkyl, aryl and arylalkyl;
Rₐ and R_{b} are independently chosen from H and methyl, in particular H;
each n is independently equal to 2, 3 or 4, in particular n is 2;
m ranges from 1 to 30, in particular m ranges from 2 to 25.

Examples of •—[(CRₐR_{b})ₙ—O]ₘ—Y groups are the alkoxylated derivatives of the alkyl, alkenyl, cycloalkyl, aryl and alkylaryl groups described above. Polyethylene glycols, polypropylene glycols, co-poly(ethylene glycol/propylene glycol) and polytetramethylene glycols comprising an end group chosen from an alkyl, alkenyl, cycloalkyl, aryl and arylalkyl group as described above are suitable in particular. These groups can in particular be obtained by reacting an alcohol R′OH having an R′ group as described above with a cyclic compound chosen from ethylene oxide, propylene oxide, tetrahydrofuran and their mixtures.

An R′ group can be a •—[(CR(Rₐ)ₚ—C(═O)O]_{q}—Z group in which:
Z is chosen from alkyl, alkenyl, cycloalkyl, aryl and arylalkyl;
R_{c} and Rₐ are independently chosen from H and methyl, in particular H;
p ranges from 3 to 5, in particular p is 5;
q ranges from 1 to 20, in particular q ranges from 2 to 10.

Examples of •—[(CR(Rₐ)ₚ—C(═O)O]_{q}—Z groups are the esterified derivatives of the alkyl, alkenyl, cycloalkyl, aryl and arylalkyl groups described above. Polyesters comprising an end group chosen from an alkyl, alkenyl, cycloalkyl, aryl and arylalkyl group as described above are suitable in particular. These groups can in particular be obtained by reacting an alcohol R′OH having an R′ group as described above with a lactone chosen from γ-butyrolactone, δ-valerolactone, ε-caprolactone and their mixtures.

According to one embodiment, each R′ is independently chosen from alkyl and •—[(CRₐR_{b})ₙ—O]ₘ—Y as defined above. In particular, each R′ is independently chosen from linear or branched C₁-C₃₀ alkyl and •—[CH₂—CH₂—O]ₘ—Y with Y a C₁-C₂₄ alkyl and m ranging from 1 to 25. More particularly, each R′ is independently chosen from branched C₈-C₂₀ alkyl and •—[CH₂—CH₂—O]ₘ—Y with Y a C₁-C₆ alkyl and m ranging from 2 to 20.

More particularly still, each R′ is independently chosen from octyl, X₁₋₆-methylheptyl, 2-ethylhexyl, nonyl, X₁₋₇-methyloctyl, decyl, X₁₋₈-methylnonyl, undecyl, X₁₋₉-methyldecyl, dodecyl, X₁₋₁₀-methylundecyl, tridecyl, X₁₋₁₁-methyldodecyl, 2,5,9-trimethyldecyl, tetradecyl, X₁₋₁₂-methyltridecyl, pentadecyl, X₁₋₁₃-methyltetradecyl, hexadecyl, X₁₋₁₄-methylpentadecyl, heptadecyl, X₁₋₁₅-methylhexadecyl, octadecyl, X₁₋₁₆-methylheptadecyl, nonadecyl, X₁₋₁₇-methyloctadecyl, icosyl, X₁₋₁₈-methylnonadecyl, henicosyl, X₁₋₁₉-methylicosyl, docosyl, X₁₋₂₀-methylhenicosyl, 2-propylheptyl, 2-propylnonyl, 2-pentylnonyl, 2-butyloctyl, 2-butyldecyl, 2-hexyloctyl, 2-hexyldecyl, 2-octyldecyl, 2-hexyldodecyl, 2-octyldodecyl, 2-decyltetradecyl, 6-methyldodecyl and isomers thereof, •—[CH₂—CH₂—O]₃—(CH₂) 3—CH₃ and •—[CH₂—CH₂—O]ₘ—CH₃ with m=2 to 20.

A compound of formula (I) can have identical or different R′ groups. A compound of formula (I) can have R′ groups having a different molecular weight. A compound of formula (I) can have R′ groups having a chemical nature, in particular a hydrophilicity, which is different.

Component b) may comprise a compound of formula (I) in which the R′ groups are identical. Component b) may comprise a compound of formula (I) in which the R′ groups are different. Component b) may comprise a compound of formula (I) in which the R′ groups are identical and a compound of formula (I) in which the R′ groups are different.

Component b) may notably comprise a compound of formula (I) in which the R′ groups are identical. The R′ groups can be identical and correspond to R₁, R₁ being a linear or branched C₁-C₃₀ alkyl, in particular a linear or branched C₈-C₂₀ alkyl, more particularly a branched C₈-C₂₀ alkyl, as described above.

Component b) may notably comprise a mixture of compounds of formula (I), said mixture containing at least one compound of formula (I) in which the R′ groups are different. The mixture can contain at least one compound of formula (I) in which the R′ groups have a different molecular weight. The mixture can contain at least one compound of formula (I) in which the R′ groups have a chemical nature, in particular a hydrophilicity, which is different.

A thixotropic additive comprising a compound of formula (I) in which the R′ groups are different can in particular be obtained by using a mixture of at least 2 different alcohols R′—OH, corresponding in particular to R₄—OH and R₅—OH, to form the compound(s) of formula (I).

In particular, the mixture of compounds of formula (1) can contain:
at least one compound of formula (I) in which the R′ groups are different, one of the R′ groups corresponding to R₄ and the other R′ group corresponding to R₅;
optionally a compound of formula (I) in which the R′ groups are identical and correspond to R₄;
optionally a compound of formula (I) in which the R′ groups are identical and correspond to R₅;
R₄ and R₅ being as defined above for R′.

The mixture of compounds of formula (I) can in particular comprise a compound of formula (Ia), optionally as a mixture with a compound of formula (Ib) and/or a compound of formula (Ic):

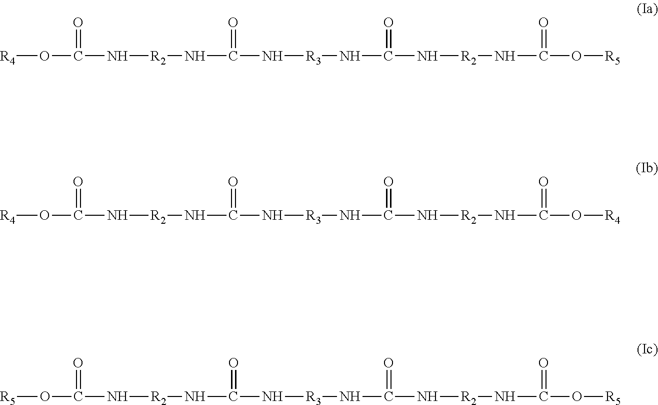

in which:
all the R₄ groups are identical and as defined above for R′;
all the R₅ groups are identical and as defined above for R′;
the Rₐ groups are different from R₅.
The R₄ group can be more hydrophobic than the R₅ group; and/or the R₅ group can have a higher molecular weight than that of the R₄ group.

The molecular weights of the R₄ and R₅ groups can be different. In particular, the R₄ group can have a lower molecular weight than that of the R₅ group. More particularly, the difference between the molecular weight of the R₄ group and that of the R₅ group can be at least 50, at least 100, at least 150, at least 200, at least 300 or at least 350 g/mol.

The chemical natures of the R₄ and R₅ groups can be different. In particular, the R₄ group can be more hydrophobic than the R₅ group.

The R₄ and R₅ groups can be groups of formula •—[(CRₐR_{b})ₙ—O]ₘ—Y having different molecular weights, Y, Rₐ, R_{b}, n and m being as defined above. Alternatively, the R₄ group can be a linear or branched C₁-C₃₀ alkyl and the R₅ group can be a group of formula •—[(CRₐR_{b})ₙ—O]ₘ—Y in which Y, Rₐ, R_{b}, n and m are as defined above.

The total molar amount of R₅ group, in particular of the least hydrophobic group and/or of the group having the highest molecular weight, can in particular represent more than 20%, in particular from 25% to 95%, 30% to 90%, 35% to 85%, or 40% to 80%, of the total molar amount of the R₄ and R₅ groups of all of the products having one or more functions chosen from urea, urethane and mixtures thereof in component b) (excluding any aprotic solvent).

Component b) may notably comprise a mixture of compounds of formula (I), said mixture containing at least two different compounds of formula (I) in which the R′ groups are different. The mixture can contain at least two different compounds of formula (I) in which the R′ groups have a different molecular weight. The mixture can contain at least two different compounds of formula (I) in which the R′ groups have a chemical nature, in particular a hydrophilicity, which is different.

A thixotropic additive comprising at least two compounds of formula (I) in which the R′ groups are different can in particular be obtained by using a mixture of at least 3 different alcohols R′—OH, corresponding in particular to R₄—OH, R₅—OH and R₆—OH, to form the diurea-diurethane compound(s) of formula (I).

The mixture of compounds of formula (I) can contain:
at least one compound of formula (I) in which the R′ groups are different, one of the R′ groups corresponding to R₄ and the other R′ group corresponding to R₅; and
at least one compound of formula (I) in which the R′ groups are different, one of the R′ groups corresponding to R₄ and the other R′ group corresponding to R₆;
optionally a compound of formula (I) in which the R′ groups are different, one of the R′ groups corresponding to R₅ and the other R′ group corresponding to R₆;
optionally a compound of formula (I) in which the R′ groups are identical and correspond to R₄;
optionally a compound of formula (1) in which the R′ groups are identical and correspond to R₅;
optionally a compound of formula (I) in which the R′ groups are identical and correspond to R₆;
R₄, R₅ and R₆ being as defined above for R′.

The mixture of compounds of formula (I) can in particular comprise a compound of formula (Ia), a compound of formula (Id) and optionally one or more compounds of formula (Ib), (Ic), (Ie) or (If) which are represented below:

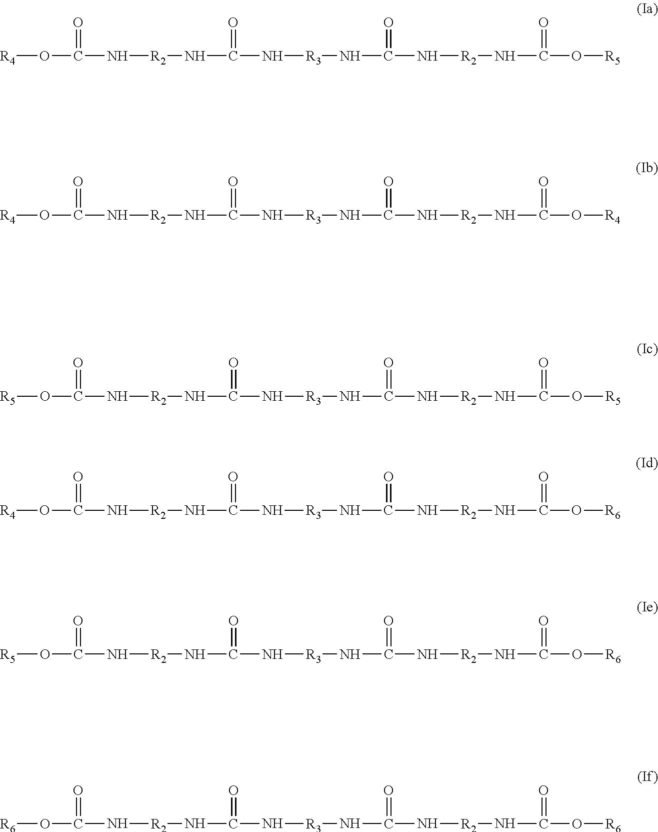

in which:
all the R₄ groups are identical and as defined above for R′;
all the R₅ groups are identical and as defined above for R′;
all the R₆ groups are identical and as defined above for R′;
the R₄ groups are different from R₅;
the R₄ groups are different from R₆;
the R₅ groups are different from R₆.

The R₄ group can be more hydrophobic than the R₅ group and/or than the R₆ group; and/or the R₄ group can have a lower molecular weight than that of the R₅ group and/or than that of the R₆ group.

The molecular weights of the R₄, R₅ and R₆ groups can be different. In particular, the R₄ group can have a lower molecular weight than that of the R₅ group; and/or the R₄ group can have a lower molecular weight than that of the R₆ group; and/or the R₅ group can have a lower molecular weight than that of the R₆ group. More particularly, the R₄ group has a lower molecular weight than those of the R₅ and R₆ groups. More particularly still, the difference between the molecular weight of the R₄ group and that of the R₅ group; and/or the difference between the molecular weight of the R₄ group and that of the R₆ group; and/or the difference between the molecular weight of the R₅ group and that of the R₆ group can be at least 50, at least 100, at least 150, at least 200, at least 300 or at least 350 g/mol.

The R₄, R₅ and R₆ groups can have different chemical natures. In particular, the R₄ group can be more hydrophobic than the R₅ group; and/or the R₄ group can be more hydrophobic than the R₆ group; and/or the R₅ group can be more hydrophobic than the R₆ group. More particularly, the R₄ group is more hydrophobic than the R₅ and R₆ groups.

The R₄ group can be a linear or branched C₁-C₃₀ alkyl and the R₅ and R₆ groups can be groups of formula •—[(CRₐR_{b})ₙ—O]ₘ—Y having different molecular weights, Y, Rₐ, R_{b}, n and m being as defined above.

The total molar amount of the R₅ and R₆ groups, in particular the total molar amount of the least hydrophobic groups and/or of the groups having the highest molecular weights, can in particular represent more than 20%, in particular from 25% to 95%, 30% to 90%, 35% to 85%, or 40% to 80%, of the total molar amount of the R₄, R₅ and R₆ groups of all of the products having one or more functions chosen from urea, urethane and mixtures thereof in component b) (excluding any aprotic solvent).

According to a preferred embodiment, more than 20 mol %, in particular from 25 to 95 mol %, 30 to 90 mol %, 35 to 85 mol %, or 40 to 80 mol %, of all of the R′ groups contained in the compound(s) of formula (I) are hydrophilic groups, in particular •—[(CRₐR_{b})ₙ—O]ₘ—Y groups.

The R′ groups can in particular be the residues of one or more alcohols of formula R′—OH without the OH group. An alcohol R′—OH can in particular be chosen from a C₁ to C₃₀ alkane substituted by an OH group, a C₂ to C₃₀ alkene substituted by an OH group, a C₅ to C₁₂ cycloalkane substituted by an OH group, a C₆ to C₁₂ arene substituted by an OH group, a C₇ to C₁₂ arylalkane substituted by an OH group, HO—[(CRₐR_{b})ₙ—O]ₘ—Y and HO—[(CR(Rₐ)ₚ—C(═O)O]_{q}—Z

Y and Z are independently chosen from C₁ to C₃₀ alkyl, C₂ to C₃₀ alkenyl, C₅ to C₁₂ cycloalkyl, C₆ to C₁₂ aryl and C to C₁₂ arylalkyl;
Rₐ, R_{b}, R_{c} and Rₐ are independently chosen from H and methyl, in particular H;
each n is independently equal to 2, 3 or 4, in particular n is 2;
m ranges from 1 to 30, in particular m ranges from 2 to 25;
p ranges from 3 to 5, in particular p is 5;
q ranges from 1 to 20, in particular q ranges from 2 to 10.

A C₁ to C₃₀ alkane substituted by an OH group can in particular be chosen from octan-1-ol, octan-2-ol, X₁₋₆-methylheptan-1-ol, 2-ethylhexan-1-ol, nonan-1-ol, X₁₋₇-methyloctan-1-ol, decan-1-ol, X₁₋₈-methylnonan-1-ol, undecan-1-ol, X₁₋₉-methyldecan-1-ol, dodecan-1-ol, X₁₋₁₀-methylundecan-1-ol, tridecan-1-ol, X₁₋₁₁-methyldodecan-1-ol, 2,5,9-trimethyldecan-1-ol, tetradecan-1-ol, X₁₋₁₂-methyltridecan-1-ol, pentadecan-1-ol, X₁₋₁₃-methyltetradecan-1-ol, hexadecan-1-ol, X₁₋₁₄-methylpentadecan-1-ol, heptadecan-1-ol, X₁₋₁₅-methylhexadecan-1-ol, octadecan-1-ol, X₁₋₁₆-methylheptadecan-1-ol, nonadecan-1-ol, X₁₋₁₇-methyloctadecan-1-ol, icosan-1-ol, X₁₋₁₈-methylnonadecan-1-ol, henicosan-1-ol, X₁₋₁₉-methylicosan-1-ol, docosan-1-ol, X₁₋₂₀-methylhenicosan-1-ol, 2-propylheptan-1-ol, 2-propylnonan-1-ol, 2-pentylnonan-1-ol, 2-butyloctan-1-ol, 2-butyldecan-1-ol, 2-hexyloctan-1-ol, 2-hexyldecan-1-ol, 2-octyldecan-1-ol, 2-hexyldodecan-1-ol, 2-octyldodecan-1-ol, 2-decyltetradecan-1-ol, 6-methyldodecan-1-ol and isomers thereof, in which X_{a-b} represents an integer which can take any value ranging from a to b, X_{a-b} indicating the position of an alkyl substituent on the alkane. X₁₋₁₁-methyldodecan-1-ol is a dodecane substituted by an

OH group in the 1 position and a methyl group in the 1, 2, 3, 4, 5, 6, 7, 8, 9, 10 or 11 position, for example 2-methyldodecan-1-ol or 11-methyldodecan-1-ol. The term “isomers” is understood to mean the alkanes comprising the same number of carbon atoms but having a different substitution scheme, for example an ethyl substituent instead of a methyl substituent or a greater number of methyl substituents. Thus, 2,5,9-trimethyldecan-1-ol is an isomer of 2-methyldodecan-1-ol and of 11-methyldodecan-1-ol. Preferably, the C₁ to C₃₀ alkane substituted by an OH group is chosen from 11-methyldodecan-1-ol and 2,5,9-trimethyldecan-1-ol.

A C₂ to C₃₀ alkene substituted by an OH group can in particular be chosen from Y₂₋₅-hexen-1-ol, Y₂₋₆-hepten-1-ol, Y₂₋₇-octen-1-ol, Y₂₋₈-nonen-1-ol, Y₂₋₉-decen-1-ol, Y₂₋₁₀-undecen-1-ol, Y₂₋₁₁-dodecen-1-ol, Y₂₋₁₂-tridecen-1-ol, Y₂₋₁₃-tetradecen-1-ol, Y₂₋₁₅-hexadecen-1-ol, Y₂₋₁₇-octadecen-1-ol, Y₂₋₁₉-icosen-1-ol, Y₂₋₂₁-docosen-1-ol, heptadeca-8,11-dien-1-ol, octadeca-9,12-dien-1-ol, nonadeca-10,13-dien-1-ol, icosa-11,14-dien-1-ol, docosa-13,16-dien-1-ol, octadeca-5,9,12-trien-1-ol, octadeca-6,9,12-trien-1-ol, octadeca-9,12,15-trien-1-ol, octadeca-9,11,13-trien-1-ol, icosa-8,11,14-trien-1-ol, icosa-11,14,17-trien-1-ol, in which Ya-b represents an integer which can take any value ranging from a to b, Y a-b indicating the position of the double bond in the alkene. Y₂₋₅-hexen-1-ol is a hexene substituted by an OH in the 1 position in which the double bond can be in the 2, 3, 4 or 5 position.

A C₅ to C₁₂ cycloalkane substituted by an OH group can in particular be chosen from cyclopentanol, cyclohexanol, cycloheptanol, cycloctanol, cyclononanol, cyclodecanol, cycloundecanol and cyclododecanol, preferably cyclopentanol and cyclohexanol.

A C₆ to C₁₂ arene substituted by an OH group can in particular be chosen from phenol, 1-or 2-naphthol, 2-, 3- or 4-phenylphenol, 2-, 3- or 4-methylphenol, 2,3-, 2,4-, 2,5-, 2,6-, 3,4-or 3,5-dimethylphenol and 2,4,6-, 2,3,5-or 2,3,6-trimethylphenol.

A C₇ to C₁₂ arylalkane substituted by an OH group can in particular be chosen from benzyl alcohol, 2-phenylethan-1-ol, 3-phenylpropan-1-ol, 4-phenylbutan-1-ol and 2-phenylbutan-1-ol, preferably benzyl alcohol and 2-phenylethan-1-ol.

An alcohol HO—[(CRₐR_{b})ₙ—O]ₘ—Y can in particular be chosen from an alkoxylated derivative of a C₁ to C₃₀ alkane substituted by an OH group as defined above, an alkoxylated derivative of a C₂ to C₃₀ alkene substituted by an OH group as defined above, an alkoxylated derivative of a C₅ to C₁₂ cycloalkane substituted by an OH group as defined above, an alkoxylated derivative of a C₆ to C₁₂ arene substituted by an OH group as defined above, an alkoxylated derivative of a C₇ to C₁₂ arylalkane substituted by an OH group as defined above. An alkoxylated derivative can in particular be an ethoxylated, propoxylated and/or butoxylated derivative, preferably an ethoxylated derivative.

Preferably, the alcohol HO—[(CRₐR_{b})ₙ—O]ₘ—Y is chosen from a polyethylene glycol monomethyl ether (MPEG), a polyethylene glycol monoethyl ether and a polyethylene glycol monobutyl ether; more preferentially an MPEG having a number-average molecular weight of from 200 to 1000 g/mol (in particular MPEG-250, MPEG-350, MPEG-400, MPEG-450, MPEG-500, MPEG-550, MPEG-650 or MPEG-750), or triethylene glycol monobutyl ether (also known as butyl triglycol (BTG)).

An alcohol HO—[(CR_{c}Rₐ)ₚ—C(═O)O]_{q}—Z can in particular be a polyester derivative of a C₁ to C₃₀ alkane substituted by an OH group as defined above, a polyester derivative of a C₂ to C₃₀ alkene substituted by an OH group as defined above, a polyester derivative of a C₅ to C₁₂ cycloalkane substituted by an OH group as defined above, a polyester derivative of a

C₆ to C₁₂ arene substituted by an OH group as defined above, a polyester derivative of a C₇ to C₁₂ arylalkane substituted by an OH group as defined above. A polyester derivative can in particular comprise a polyester part obtained by ring opening polymerization of a lactone, preferably chosen from γ-butyrolactone, δ-valerolactone, ε-caprolactone and their mixtures.

### R₂ Group

A compound of formula (I) contains two R₂ groups. The R₂ groups of one and the same compound of formula (I) can be identical or different. Component b) may comprise a mixture of compounds of formula (I) having identical R₂ groups. Component b) may comprise a mixture of compounds of formula (I) which differ in their R₂ groups. For example, some compounds of the mixture can have identical R₂ groups and some compounds of the mixture can have different R₂ groups.

Each R₂ group can originate from the use of a diisocyanate of formula OCN—R₂—NCO in order to form the diurea-diurethane compound(s) of formula (I). The R₂ group can correspond to the residue of a diisocyanate of formula OCN—R₂—NCO without the NCO groups. The R₂ groups and the corresponding diisocyanates of formula OCN—R₂—NCO described below also apply to the process according to the invention.

Each R₂ is independently a divalent group chosen from an aliphatic group, a cycloaliphatic group, an aromatic group and an araliphatic group.

According to one embodiment, each R₂ is independently an aromatic group.

In particular, each R₂ is independently an aromatic group having the following formula:

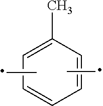

in which the symbol • represents a point of attachment to a urea or urethane group of the formula (I).

More particularly, each R₂ is independently an aromatic group having one of the following formulae:

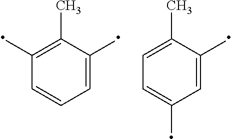

in which the symbol • represents a point of attachment to a urea or urethane group of the formula (I).

Component b) may in particular have more than 85 mol %, more than 90 mol %, more than 95 mol %, more than 97 mol %, more than 98 mol %, more than 99 mol %, or 100 mol %, of all of the R₂ groups contained in the compound(s) of formula (I) which are aromatic groups of the following formula:

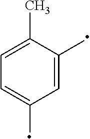

in which the symbol • represents a point of attachment to a urea or urethane group of the formula (I).

In particular, component b) may have from 86 to 100 mol %, from 90 to 100 mol %, from 95 to 100 mol %, from 97 to 100 mol %, from 98 to 100 mol %, from 99 to 100 mol %, or 100 mol %, of all of the R₂ groups contained in the compound(s) of formula (I) which are aromatic groups of the following formula:

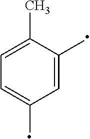

in which the symbol • represents a point of attachment to a urea or urethane group of the formula (I).

The R₂ group is bonded, on one side, to a urethane group (originating from the reaction between an isocyanate group of the diisocyanate OCN—R₂—NCO and the OH group of the alcohol R′OH) and, on the other side, to a urea group (originating from the reaction between the other isocyanate group of the diisocyanate OCN—R₂—NCO and an NH₂ group of the diamine H₂N—R₃—NH₂).

More particularly still, each R₂ is independently an aromatic group of the following formula:

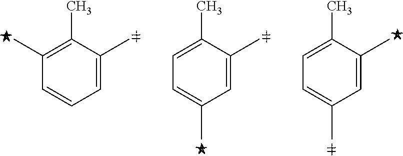

in which the symbol ★ represents a point of attachment to a urethane group of the formula (I) and the symbol [symbol] represents a point of attachment to a urea group of the formula (I).

When the R₂ group is asymmetric, there may be a side of the R₂ group which is preferably bonded to the urethane group and the other side which is preferably bonded to the urea group. Without wishing to be committed to any one theory, the Applicant Company assumes that the least hindered side of the R₂ group is preferably bonded to the urethane group.

Component b) may in particular have more than 60 mol %, more than 65 mol %, more than 70 mol %, more than 75 mol %, more than 80 mol %, more than 85 mol %, or more than 90 mol %, of all of the R₂ groups contained in the compound(s) of formula (I) which are aromatic groups of the following formula:

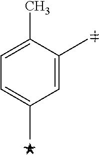

in which the symbol ★ represents a point of attachment to a urethane group of the formula (I) and the symbol [symbol] represents a point of attachment to a urea group of the formula (I).

In particular, component b) may have from 61 to 100 mol %, from 65 to 100 mol %, from 70 to 100 mol %, from 75 to 100 mol %, from 80 to 100 mol %, from 85 to 100 mol %, or from 90 to 100 mol %, of all of the R₂ groups contained in the compound(s) of formula (I) which are aromatic groups of the following formula:

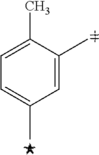

in which the symbol ★ represents a point of attachment to a urethane group of the formula (I) and the symbol [symbol] represents a point of attachment to a urea group of the formula (I).

The R₂ groups can in particular be the residues of one or more diisocyanates of formula OCN—R₂—NCO without the NCO groups. A diisocyanate of formula OCN—R₂—NCO can be a toluene diisocyanate (TDI). A TDI can be in the form of one or more isomers chosen from toluene-2,4-diisocyanate and toluene-2,6-diisocyanate.

In the context of the present invention, it is advantageous to use a TDI which comprises a high proportion of toluene-2,4-diisocyanate, indeed even a TDI which comprises only toluene-2,4-diisocyanate. The Applicant Company assumes that the asymmetry of this compound makes it possible to decrease the amount of by-products, in particular of compound of formula (II), in component b). This makes it possible to obtain compounds of formula (I) having a high proportion, indeed even consisting exclusively, of R₂ groups according to the following formula:

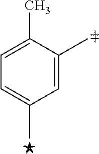

in which the symbol ★ represents a point of attachment to a urethane group of the formula (I) and the symbol [symbol] represents a point of attachment to a urea group of the formula (I).

In particular, a diisocyanate of formula OCN—R₂—NCO is a TDI containing more than 85 mol %, more than 90 mol %, more than 95 mol %, more than 97 mol %, more than 98 mol %, more than 99 mol %, or 100 mol %, of toluene-2,4-diisocyanate, with respect to the total amount of toluene diisocyanate isomers. More particularly, a diisocyanate of formula OCN—R₂—NCO is a TDI containing from 86 to 100 mol %, from 90 to 100 mol %, from 95 to 100 mol %, from 97 to 100 mol %, from 98 to 100 mol %, from 99 to 100 mol %, or 100 mol %, of toluene-2,4-diisocyanate, with respect to the total amount of toluene diisocyanate isomers. Preferably, a diisocyanate of formula OCN—R₂—NCO is a TDI containing 100 mol % of toluene-2,4-diisocyanate, with respect to the total amount of toluene diisocyanate isomers.

### R₃ Group

A compound of formula (I) contains an R₃ group. Component b) may comprise a mixture of compounds of formula (I) having identical R₃ groups. Component b) may comprise a mixture of compounds of formula (I) which differ in their R₃ groups.

Each R₃ group can originate from the use of a diamine of formula H₂N—R₃—NH₂ in order to form the diurea-diurethane compound(s) of formula (I). The R₃ group can correspond to the residue of a diamine of formula H₂N—R₃—NH₂ without the NH₂ groups. The R₃ groups and the corresponding diamines of formula H₂N—R₃—NH₂ described below also apply to the process according to the invention.

Each R₃ is independently a divalent group chosen from an aliphatic group, a cycloaliphatic group, an aromatic group, an araliphatic group and a heterocyclic group.

According to a specific embodiment, each R₃ is independently a group chosen from C₂-C₂₄ alkylene, —(CRₕRᵢ)ₛ—[A-(CRⱼRₖ)ₜ]ᵤ—, —(CRₗRₘ)ᵥ—CY—(CRₙRₒ)_{w}— and —(CRₚR_{q})ₓ—CY—(CH₂)_{y}—CY—(CRᵣRₛ)_{z}—;
in which:
A is O or NX;
Rₕ, Rᵢ, Rⱼ, Rₖ, Rₗ, Rₘ, Rₙ, Rₒ, Rₚ, R_{q}, Rᵣ and Rₛ are independently chosen from H and methyl, in particular H;
X is a C₁ to C₆ alkyl, in particular methyl or ethyl;
CY is a ring chosen from phenyl, cyclohexyl, naphthyl, decahydronaphthyl, piperazinyl, triazinyl and pyridinyl, the ring being unsubstituted or substituted by 1 to 3 C₁-C₄ alkyl groups;
s ranges from 2 to 4, in particular s is 2;
t ranges from 2 to 4, in particular t is 2;
u ranges from 1 to 30;
v, w, x, y and z independently range from 0 to 4.

Each R₃ can in particular be a group chosen from C₂-C₂₄ alkylene and —(CRₗRₘ)ᵥ—CY—(CRₗRₒ)_{w}—;

in particular a group chosen from C₂-C₁₈ alkylene and —(CH₂)ᵥ—CY—(CH₂)_{w}— with CY a cyclohexyl or phenyl ring, the ring being unsubstituted or substituted by 1 to 3 C₁-C₄ alkyl groups, v and w ranging from 0 to 1.

More particularly, each R₃ can be a group chosen from C₂-C₆ alkylene and a group having the following formula:

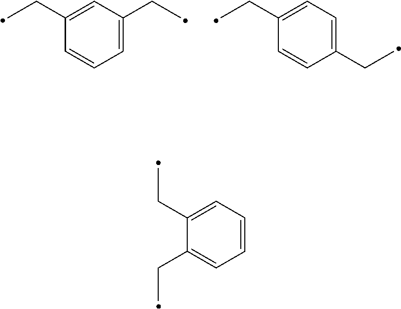

in which the symbol • represents a point of attachment to a urea group of the compound of formula (I).

Component b) may in particular have more than 85 mol %, more than 90 mol %, more than 95 mol %, more than 97 mol %, more than 98 mol %, more than 99 mol %, or 100 mol %, of all of the R₃ groups contained in the compound(s) of formula (I) which are groups of the following formula:

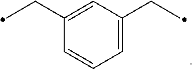

In particular, component b) may have from 86 to 100 mol %, from 90 to 100 mol %, from 95 to 100 mol %, from 97 to 100 mol %, from 98 to 100 mol %, from 99 to 100 mol %, or 100 mol %, of all of the R₃ groups contained in the compound(s) of formula (I) which are groups of the following formula:

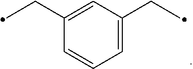

The R₃ group(s) can in particular be the residue(s) of a (of one or more)diamine(s) of formula H₂N—R₃—NH₂ without the NH₂ groups. A diamine of formula H₂N—R₃—NH₂ can be chosen from a C₂ to C₂₄ aliphatic diamine, a C₆ to C₁₈ cycloaliphatic diamine, a C₆ to C₂₄ aromatic diamine, a C₇ to C₂₆ araliphatic diamine and a C₃ to C₁₈ heterocyclic diamine.

A C₂ to C₂₄ aliphatic diamine is a diamine of formula H₂N—R₃—NH₂ in which R₃ is an aliphatic group comprising from 2 to 24 carbon atoms. An aliphatic diamine can be linear or branched, preferably linear. An aliphatic diamine can be a polyetheramine, that is to say a diamine of formula H₂N—R₃—NH₂ in which R₃ comprises ether (—O—) bonds, more particularly ethylene oxide (—O—CH₂—CH₂) and/or propylene oxide (—O—CH₂—CHCH₃—) units.

An aliphatic diamine can be a polyalkyleneimine, that is to say a diamine of formula H₂N—R₃—NH₂ in which R₃ is interrupted by one or more tertiary amines (—NX— with X a C₁ to C₆ alkyl). An aliphatic diamine can be interrupted by one or more tertiary amine groups. Examples of linear aliphatic diamines which are suitable are 1,2-ethylenediamine, 1,3-propylenediamine, 1,4-tetramethylenediamine, 1,5-pentamethylenediamine, 1,6-hexamethylenediamine, 1,8-octamethylenediamine, 1,12-dodecamethylenediamine and their mixtures; preferably 1,2-ethylenediamine, 1,5-pentamethylenediamine and 1,6-hexamethylenediamine. Examples of branched aliphatic diamines which are suitable are 1,2-propylenediamine, 2,2-dimethyl-1,3-propanediamine, 2-butyl-2-ethyl-1,5-pentanediamine and their mixtures. Examples of polyetheramines are the compounds sold by Huntsman under the Jeffamine® reference, in particular the Jeffamine® D, ED and EDR series (diamines). These series include in particular the following references: Jeffamine® D-230, Jeffamine® D-400, Jeffamine® D-2000, Jeffamine® D-4000, Jeffamine® ED-600, Jeffamine® ED-900, Jeffamine® ED-2003, Jeffamine® EDR-148 and Jeffamine® EDR-176. An example of polyalkyleneimine is 3,3′-diamino-N—methyldipropylamine.

A C₆ to C₁₈ cycloaliphatic diamine is a diamine of formula H₂N—R₃—NH₂ in which R₃ is a cycloaliphatic group comprising from 6 to 18 carbon atoms. Examples of cycloaliphatic diamines which are suitable are 1,2—, 1,3- or 1,4-diaminocyclohexane, 2-methylcyclohexane-1,3-diamine, 4-methylcyclohexane-1,3-diamine, isophoronediamine, 1,2—, 1,3- or 1,4-bis(aminomethyl)cyclohexane, diaminodecahydronaphthalene, 3,3′-dimethyl-4,4′-diaminodicyclohexylmethane, 4,4′-diaminodicyclohexylmethane, bis(aminomethyl) norbornane and their mixtures;
preferably, 1,3- or 1,4-bis(aminomethyl)cyclohexane, 1,2—, 1,3- or 1,4-bis(aminomethyl)cyclohexane, isophoronediamine and 4,4′-diaminodicyclohexylmethane.

A C₆ to C₂₄ aromatic diamine is a diamine of formula H₂N—R₃—NH₂ in which R₃ is an aromatic group comprising from 6 to 24 carbon atoms. Examples of aromatic diamines which are suitable are ortho-, meta- and para-phenylenediamine, ortho-, meta- and para-tolylenediamine, 3,4′-diaminodiphenyl ether, 4,4′-diaminodiphenyl ether and their mixtures; preferably, ortho-, meta- and para-phenylenediamine.

A C₇ to C₂₆ araliphatic diamine is a diamine of formula H₂N—R₃—NH₂ in which R₃ is an araliphatic group comprising from 7 to 26 carbon atoms. Examples of araliphatic diamines which are suitable are ortho-, meta- and para-xylylenediamine, 4,4′-diaminodiphenylmethane and their mixtures; preferably, ortho-, meta- and para-xylylenediamine.

A C₃ to C₁₈ heterocyclic diamine is a diamine of formula H₂N—R₃—NH₂ in which R₃ is a heterocyclic group comprising from 3 to 18 carbon atoms. Examples of heterocyclic diamines which are suitable are 1,2-diaminopiperazine, 1,4-diaminopiperazine, 1,4-bis(3-aminopropyl) piperazine, 2,3—, 2,6— and 3,4-diaminopyridine, 2,4-diamino-1,3,5-triazine and their mixtures.

### Aprotic Solvent

Component b) may further comprise an aprotic solvent. Component b) may comprise a mixture of aprotic solvents.

According to one embodiment, the aprotic solvent is chosen from dimethyl sulfoxide, N,N-dimethylformamide, N,N-dimethylacetamide, N-methylpyrrolidone, N-ethylpyrrolidone, N-propylpyrrolidone, N-butylpyrrolidone, N,N,N′,N′-tetramethylurea and their mixtures. In particular, the aprotic solvent is chosen from dimethyl sulfoxide, N-butylpyrrolidone and their mixtures.

Component b) may in particular comprise from 20% to 95% by weight, in particular from 40% to 80% by weight and more particularly from 50% to 70% by weight of aprotic solvent, relative to the weight of component b).

### Diurethane Compound

Component b) may further comprise a diurethane compound. Component b) may comprise a mixture of diurethane compounds.

The diurethane compound can be a by-product resulting from the process for the preparation of component b) as described below. This is because the reaction between a diisocyanate of formula OCN—R₂—NCO and an alcohol of formula R′—OH in order to form a monoisocyanate adduct of formula R′—O—C(═O)—NH—R₂—NCO can also generate a diurethane when the alcohol is in stoichiometric excess with respect to the diisocyanate. Without wishing to be committed to any one theory, the Applicant Company assumes that the diurethane makes it possible to stabilize component b) and to reduce the number of by-products obtained during its preparation. The presence of diurethane in component b) makes it possible to eliminate or to greatly reduce the amount of salt, in particular of lithium salt, or of surfactant, relative to the thixotropic additives of the prior art. A diurethane compound can in particular correspond to a compound of formula (II):

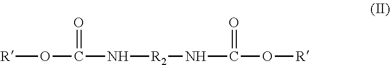

in which R′ and R₂ are as defined above for the compound of formula (I).

According to a specific embodiment, component b) comprises from 20 to 95 mol %, in particular from 25 to 85 mol %, more particularly from 35 to 75 mol %, of compound of formula (II), relative to the total molar amount of compounds having one or more functions chosen from urea, urethane and mixtures thereof (excluding any aprotic solvent).

### Polyurea-Diurethane Compound

Component b) may further comprise a polyurea-diurethane compound. Component b) may comprise a mixture of polyurea-diurethane compounds.

The polyurea-diurethane compound may notably be a by-product resulting from the process for the preparation of component b) as described below. This is because the reaction between a monoisocyanate adduct of formula R′—O—C(═O)—NH—R₂—NCO and a diamine of formula H₂N—R₃—NH₂ can also generate a polyurea-diurethane when the reaction medium contains diisocyanate of formula OCN—R₂—NCO. The diisocyanate can in particular be residual diisocyanate originating from the reaction between a diisocyanate of formula OCN—R₂—NCO and an alcohol of formula R′—OH in order to form the monoisocyanate adduct of formula R′—O—C(═O)—NH—R₂—NCO.

A polyurea-diurethane compound can in particular correspond to a compound of formula (III):

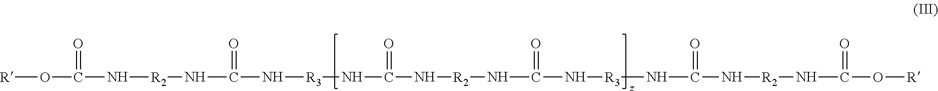

in which R′, R₂ and R₃ are as defined above for the compound of formula (I);
z is from 1 to 10.

As the polyurea-diurethane compounds are generally solids, it is advantageous to limit their amount in component b). Although it is possible to reduce the content of residual diisocyanate by carrying out a distillation step before the reaction between the monoisocyanate adduct and the diamine, this represents a not insignificant cost and requires specific equipment. Component b) has a low content of polyurea-diurethane compound even though its process of preparation does not require a step of distillation of residual diisocyanate. This is rendered possible in particular by adjusting the molar ratio of the reactants employed in the process for the preparation of component b) as described below.

According to a specific embodiment, component b) comprises less than 4 mol %, in particular from 3.0 to 1.5 mol %, from 2.0 to 1.0 mol %, or from 1.0 to 0 mol %, of compound of formula (III), relative to the total molar amount of compounds having one or more functions chosen from urea, urethane and mixtures thereof (excluding any aprotic solvent).

### Process for Preparing the Thixotropic Additive

Component b) may be prepared according to the process described below.

The process for preparing component b) comprises a step a), a step b) and optionally one or more additional steps which can take place before step a), between step a) and step b), and/or after step b).

Step a) is a step during which at least one diisocyanate of formula OCN—R₂—NCO reacts with at least one alcohol of formula R′—OH in order to form at least one monoisocyanate adduct of formula R′—O—C(═O)—NH—R₂—NCO.

Step b) is a step during which the at least one monoisocyanate adduct obtained in step a) reacts with at least one diamine of formula H₂N—R₃—NH₂ in order to form at least one compound of formula (I):

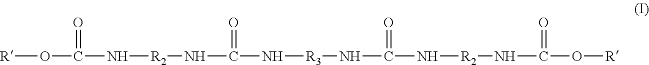

in which:
each R′ is independently chosen from alkyl, alkenyl, cycloalkyl, aryl, arylalkyl, •—[(CRₐR_{b})ₙ—O]ₘ—Y and •—[(CR(Rₐ)ₚ—C(═O)O]_{q}—Z;
the symbol • represents a point of attachment to a urethane group of the formula (I);
each R₂ is independently a divalent group chosen from an aliphatic group, a cycloaliphatic group, an aromatic group and an araliphatic group;
each R₃ is independently a divalent group chosen from an aliphatic group, a cycloaliphatic group, an aromatic group, an araliphatic group and a heterocyclic group;
Y and Z are independently chosen from alkyl, alkenyl, cycloalkyl, aryl and arylalkyl;
Rₐ, R_{b}, R_{c} and Rₐ are independently chosen from H and methyl, in particular H;
each n is independently equal to 2, 3 or 4, in particular n is 2;
m ranges from 1 to 30, in particular m ranges from 2 to 25;
p ranges from 3 to 5, in particular p is 5;
q ranges from 1 to 20, in particular q ranges from 2 to 10.

The R′, R₂ and R₃ groups, the diisocyanate of formula OCN—R₂—NCO, the alcohol of formula R′—OH and the diamine of formula H₂N—R₃—NH₂ can in particular be as defined above for the compound of formula (I). The specific embodiments described for the compound of formula (1) also apply to the process for preparing component b).

Step a) can in particular be carried out by gradually adding the at least one alcohol to a reactor containing the at least one diisocyanate. The at least one diisocyanate can in particular be in the molten state. The rate of addition of the at least one alcohol can be controlled in order to limit the exothermicity. In particular, the rate of addition of the at least one alcohol can be controlled in order to keep the temperature of the reaction medium less than or equal to 60° C., in particular from 20° C. to 60° C., from 25° C. to 55° C. or from 30° C. to 40° C.

Step a) is carried out with a molar ratio of the total amount of alcohol to the total amount of diisocyanate of from 1.10 to 1.80. In particular, the molar ratio of the total amount of alcohol to the total amount of diisocyanate in step a) ranges from 1.20 to 1.60, more particularly from 1.25 to 1.45, more particularly still from 1.30 to 1.40.

The ratio of alcohol with respect to the diisocyanate in step a) makes it possible to limit the amount of residual diisocyanate at the end of step a). The amount of residual diisocyanate at the end of step a) corresponds to the amount of diisocyanate introduced in step a) which has not reacted with the at least one alcohol. Controlling the amount of residual diisocyanate at the end of step a) advantageously makes it possible to limit the formation of insoluble species, in particular of compound of formula (III) as described above, during step b). According to a specific embodiment, the amount of residual diisocyanate in the reaction mixture at the end of step a) is less than 6 mol %, in particular from 0 to 5 mol %, from 0.01 to 4.5 mol % or from 0.05 to 4 mol %, with respect to the molar amount of all of the compounds having one or more functions chosen from urethane, isocyanate and mixtures thereof.

The ratio of alcohol with respect to the diisocyanate in step a) advantageously makes it possible to avoid the implementation of a step of removing residual diisocyanate. This is because the amount of residual diisocyanate at the end of step a) is sufficiently low and will not generate an excessive formation of insoluble species, in particular of compound of formula (III) as described above, during step b). According to a specific embodiment, the process for preparing component b) does not comprise a step of distillation of residual diisocyanate, in particular does not comprise a step of distillation of residual diisocyanate between step a) and step b).

The ratio of alcohol with respect to the diisocyanate in step a) can result in the formation of one or more diurethane compound(s) as described above. A diurethane compound can in particular result from the reaction between an alcohol of formula R′—OH and the monoisocyanate adduct of formula R′—O—C(═O)—NH—R₂—NCO. Thus, the reaction mixture obtained in step a) can comprise the monoisocyanate adduct of formula R′—O—C(═O)—NH—R₂—NCO and a compound of formula (II):

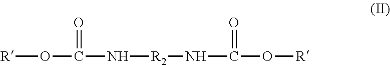

in which R′ and R₂ are as defined above.

Without wishing to be committed to any one theory, the Applicant Company assumes that the presence of diurethane compound in component b) makes it possible to stabilize the urea bonds formed during step b). Thus, it is possible to greatly reduce, indeed even to eliminate, the amount of stabilizer (in particular of salt, for example of lithium salt, or of surfactant) added in step b), in comparison with the processes of the prior art.

Once the addition of the at least one alcohol is complete, step a) can be continued until the NCO index of the reaction mixture reaches the theoretical NCO index. The NCO index at the end of step a) can in particular be less than 200 mg KOH/g. In particular, the NCO index at the end of step a) can be from 5 to 150 mg KOH/g, from 25 to 125 mg KOH/g, from 50 to 100 mg KOH/g or from 60 to 80 mg KOH/g. The NCO index at the end of step a) can in particular be measured according to the method described below. The theoretical

NCO index at the end of step a) can in particular be calculated according to the method described below.

Step b) can in particular be carried out by gradually adding the mixture obtained in step a) to a reactor containing the at least one diamine and optionally aprotic solvent and/or salt. The rate of addition of the mixture obtained in step a) can be controlled in order to limit the exothermicity. In particular, the rate of addition of the mixture obtained in step a) can be controlled in order to keep the temperature of the reaction medium below or equal to 80° C., in particular from 20° C. to 80° C., from 30° C. to 70° C. or from 40° C. to 60° C.

Once the addition of the at least one monoisocyanate adduct is complete, step b) can be continued until the NCO index of the reaction mixture reaches the desired value. The NCO index of the thixotropic additive obtained by the process for preparing component b) can notably be less than 0.5 mg KOH/g, in particular less than 0.2 mg KOH/g, more particularly less than 0.1 mg KOH/g, more particularly still 0 mg KOH/g. The NCO index of the thixotropic additive may notably be determined according to the method described in the patent application filed under the number PCT/EP2021/084323.

Step b) is carried out in the presence of less than 0.2 mol of salt per mole of diamine used. In particular, step b) is carried out in the presence of from 0 to 0.19, from 0 to 0.15, from 0 to 0.1, from 0 to 0.05, from 0 to 0.02, from 0 to 0.01 or 0 mol of salt per mole of diamine used. The salt can in particular be as defined above for component b).

Step b) can be carried out in the presence of less than 0.2 mol of surfactant per mole of diamine used. In particular, step b) is carried out in the presence of from 0 to 0.19, from 0 to 0.15, from 0 to 0.1, from 0 to 0.05, from 0 to 0.02, from 0 to 0.01 or 0 mol of surfactant per mole of diamine used. The surfactant can in particular be as defined above for component b).

The molar ratio of the total amount of monoisocyanate adduct to the total amount of diamine in step b) can range from 1.8 to 2.2. In particular, the molar ratio of the total amount of monoisocyanate adduct to the total amount of diamine in step b) ranges from 1.9 to 2.1, more particularly from 1.95 to 2.05, more particularly still from 1.98 to 2.02.

A solvent can be added in step a) and/or in step b) and/or between step a) and step b) in order to reduce the viscosity of the composition and to dissolve the compounds obtained.

In particular, step a) and/or step b) can be carried out in the presence of an aprotic solvent. The viscosity of the reaction medium obtained at the end of step a) can be lowered by adding aprotic solvent. The aprotic solvent can in particular be as defined above for component b).

The process for preparing component b) can be carried out using an alcohol or a mixture of alcohols in step a).

According to a first embodiment, in step a), the at least one diisocyanate reacts with a single alcohol of formula R₁—OH in order to form at least one monoisocyanate adduct of formula R₁—O—C(═O)—NH—R₂—NCO and, in step b), the product obtained in step a) reacts with at least one diamine of formula H₂N—R₃—NH₂ in order to form at least one compound of formula (I′):

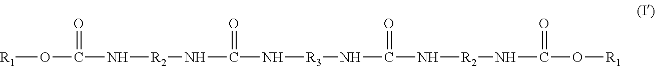

wherein
the R₁ groups are identical and as defined above for R′;
R₂ and R₅ are as defined above.

The alcohol Rᵢ—OH of the first embodiment can in particular be a linear or branched C₁-C₃₀ alkyl substituted by OH.

According to a second embodiment, in step a), the at least one diisocyanate reacts with at least two different alcohols of formulae R₄—OH and R₅—OH in order to form a mixture of at least two monoisocyanate adducts of formulae R₄—O—C(═O)—NH—R₂—NCO and R₅—O—C(═O)—NH—R₂—NCO and,
in step b), the mixture obtained in step a) reacts with at least one diamine of formula H₂N—R₃—NH₂ in order to form at least one compound of formula (Ia), optionally as a mixture with a compound of formula (Ib) and/or a compound of formula (Ic):

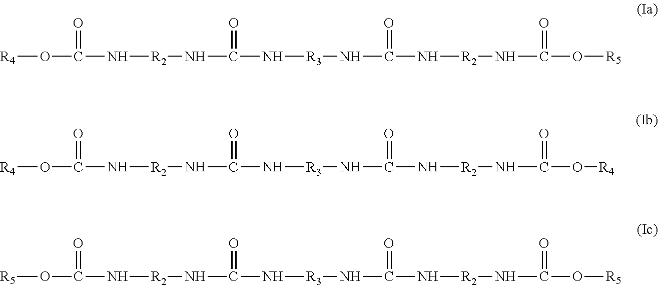

in which:
all the R₄ groups are identical and as defined above for R′;
all the R₅ groups are identical and as defined above for R′;
the Rₐ groups are different from R₅.

The R₄ and R₅ groups, and also the alcohols of formulae R₄—OH and R₅—OH, can in particular be as defined above for the compound of formula (I).

In the second embodiment, the alcohol R₄—OH can be more hydrophobic than the alcohol R₅—OH; and/or the alcohol R₅—OH can have a higher molecular weight than that of the alcohol R₄—OH.

In the second embodiment, the molecular weights of the alcohols R₄—OH and R₅—OH can be different. In particular, R₄—OH can have a lower molecular weight than that of R₅—OH. More particularly, the difference between the molecular weight of R₄—OH and that of R₅—OH can be at least 50, at least 100, at least 150, at least 200, at least 300 or at least 350 g/mol.

In the second embodiment, the chemical natures of the alcohols R₄—OH and R₅—OH can be different. In particular, the alcohol R₄—OH can be more hydrophobic than the alcohol R₅—OH.

In the second embodiment, the alcohols R₄—OH and R₅—OH can be alcohols of formula HO—[(CRₐR_{b})ₙ—O]ₘ—Y having different molecular weights, Y, Rₐ, R_{b}, n and m being as defined above. Alternatively, the alcohol R₄—OH can be a linear or branched C₁-C₃₀ alkyl substituted by OH and the alcohol R₅—OH can be an alcohol of formula HO—[(CRₐR_{b})ₙ—O]ₘ—Y in which Y, Rₐ, R_{b}, n and m are as defined above.

In the second embodiment, the total molar amount of the alcohol R₅—OH, in particular of the least hydrophobic alcohol and/or of the alcohol having the highest molecular weight, can notably represent more than 20%, in particular from 25% to 95%, from 30% to 90%, from 35% to 85%, or from 40% to 80%, of the total molar amount of the alcohols R₄—OH and R₅—OH introduced in step a).

In the second embodiment, the alcohol R₅—OH, in particular the least hydrophobic alcohol and/or the alcohol having the highest molecular weight, can notably be reacted with the diisocyanate before the alcohol R₄—OH, in particular the most hydrophobic alcohol and/or the alcohol having the lowest molecular weight, is introduced into the reaction mixture of step a).

According to a third embodiment, in step a), the diisocyanate reacts with a mixture of at least three different alcohols of formulae R₄—OH, R₅—OH and R₆—OH in order to form a mixture of at least three monoisocyanate adducts of formulae R₄—O—C(═O)—NH—R₂—NCO, R₅—O—C(═O)—NH—R₂—NCO and R₆—O—C(═O)—NH—R₂—NCO and, in step b), the mixture obtained in step a) reacts with at least one diamine of formula H₂N—R₃—NH₂ in order to form a compound of formula (Ia), a compound of formula (Id) and optionally one or more compounds of formula (Ib), (Ic), (Ie) or (If) represented below:

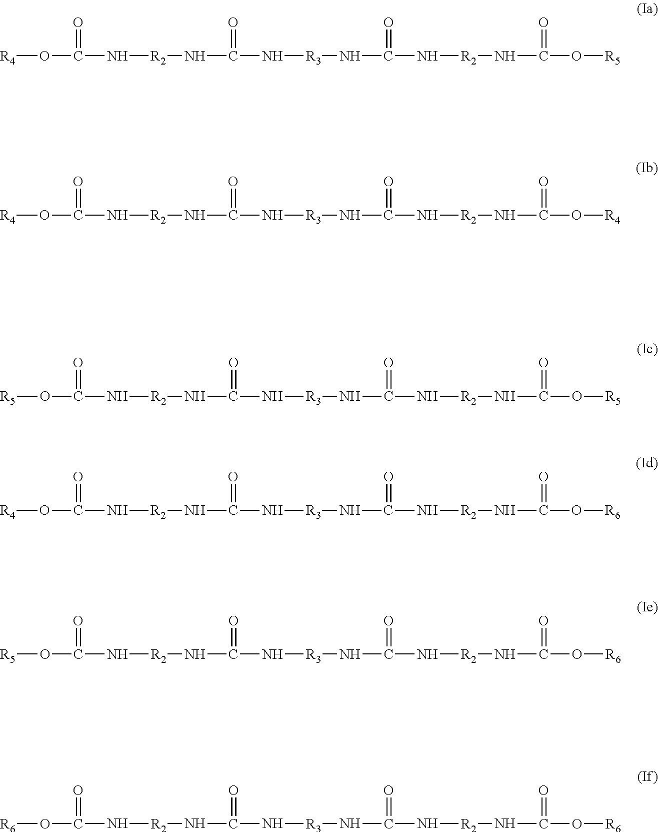

in which:
all the R₄ groups are identical and as defined above for R′;
all the R₅ groups are identical and as defined above for R′;
all the Re groups are identical and as defined above for R′;
the R₄ groups are different from R₅;
the R₄ groups are different from R₆;
the R₅ groups are different from R₆.

The R₄, R₅ and R₆ groups, and also the alcohols of formulae R₄—OH, R₅—OH and R₆—OH, can in particular be as defined above for the compound of formula (I).

In the third embodiment, the alcohol R₄—OH can be more hydrophobic than the alcohol R₅—OH and/or than the alcohol R₆—OH; and/or the alcohol R₄—OH can have a lower molecular weight than that of the alcohol R₅—OH and/or than that of the alcohol R₆—OH.

In the third embodiment, the molecular weights of the alcohols R₄—OH, R₅—OH and R₆—OH can be different. In particular, R₄—OH can have a lower molecular weight than that of R₅—OH; and/or R₄—OH can have a lower molecular weight than that of R₆—OH; and/or R₅—OH can have a lower molecular weight than that of R₆—OH. More particularly, the alcohol R₄—OH has a lower molecular weight than those of the alcohols R₅—OH and R₆—OH. More particularly still, the difference between the molecular weight of R₄—OH and that of R₅—OH; and/or the difference between the molecular weight of R₄—OH and that of R₆—OH; and/or the difference between the molecular weight of R₅—OH and that of R₆—OH can be at least 50, at least 100, at least 150, at least 200, at least 300 or at least 350 g/mol.

The alcohols R₄—OH, R₅—OH and Re—OH can have different chemical natures. In particular, R₄—OH can be more hydrophobic than R₅—OH; and/or R₄—OH can be more hydrophobic than R₆—OH; and/or R₅—OH can be more hydrophobic than R₆—OH. More particularly, the alcohol R₄—OH is more hydrophobic than the alcohols R₅—OH and R₆—OH.

In the third embodiment, the alcohol R₄—OH can be a linear or branched C₁-C₃₀ alkyl substituted by OH and the alcohols R₅—OH and R₆—OH can be alcohols of formula HO—[(CRₐR_{b})ₙ—O]ₘ—Y having different molecular weights, Y, Rₐ, R_{b}, n and m being as defined above.

The total molar amount of the alcohols R₅—OH and R₆—OH, in particular the total molar amount of the least hydrophobic alcohols and/or of the alcohols having the highest molecular weights, can notably represent more than 20%, especially from 25% to 95%, from 30% to 90%, from 35% to 85%, or from 40% to 80%, of the total molar amount of the alcohols R₄—OH, R₅—OH and R₆—OH introduced in step a).

The alcohols R₅—OH and R₆—OH, in particular the least hydrophobic alcohols and/or the alcohols having the highest molecular weights, can notably be reacted with the diisocyanate before the alcohol R₄—OH, in particular the most hydrophobic alcohol and/or the alcohol having the lowest molecular weight, is introduced into the reaction mixture of step a).

### Composition

The composition according to the invention comprises a polymerizable component and a thixotropic additive as are described above.

The composition may notably comprise from 50% to 99.95%, in particular from 70% to 99.9%, more particularly from 80% to 99.8%, more particularly still from 90% to 99.75% by weight of component a) relative to the weight of the composition.

The thixotropic additive may notably be added in an amount sufficient to increase the viscosity and/or to impart thixotropic properties to the composition according to the invention.

The composition may notably comprise from 0.05% to 50%, in particular from 0.1% to 30%, more particularly from 0.2% to 20%, more particularly still from 0.25% to 10% by weight of component b) relative to the weight of the composition.

The composition may notably have a viscosity greater than the viscosity of a composition which does not comprise component b) or which comprises an insufficient amount of component b), the viscosity being measured at 25° C. at low shear (0.01 s-1).

According to a particular embodiment, the composition is a coating composition, a moulding composition, a mastic composition, an adhesive composition, a liquid waterproofing composition, a composite material composition, a chemical sealing composition or a dental material composition.

The composition according to the invention may further comprise one or more additional components chosen from fillers, plasticizers, wetting agents, pigments, antioxidants, radical inhibitors, UV absorbers, light stabilizers and mixtures thereof.

The composition according to the invention may comprise a filler, in particular a filler chosen from a mineral filler, and organic filler or mixtures thereof. In particular, the composition may comprise a mineral filler, notably chosen from gravel, marble, granite, quartz, diatomaceous earth, feldspar, mica, gypsum, glass beads, rock dust, limestone, ceramic, clay, loam, carbon black, graphite, sand, silica, alumina, titanium dioxide, magnesium oxide, zirconium dioxide, talc, aluminium hydroxide, magnesium hydroxide, calcium hydroxide, zirconium hydroxide, calcium phosphate, calcium carbonate, calcium sulfate, barium sulfate and mixtures thereof.

The composition may comprise an organic filler, notably chosen from polymer particles such as polyolefin particles (notably polyethylene, polytetrafluoroethylene or polypropylene particles) polyester particles, polyether particles, (meth)acrylic polymer particles (notably polymethyl methacrylate particles), polyurethane particles, polyamide particles (notably of Orgasol® type), styrene-maleic copolymer particles; natural or synthetic waxes such as paraffin, microcrystalline wax, ceresin, montan wax, beeswax, candelilla wax, carnauba wax, rice bran wax, Japan wax, soy wax, rapeseed wax, palm wax, spermaceti, shea butter, cocoa butter, tristearin, hydrogenated castor oil, hydrogenated coconut oil, hydrogenated cottonseed oil, hydrogenated rapeseed oil, hydrogenated soybean oil, hydrogenated palm oil; gums such as guar gum and xanthan gum; and mixtures thereof.

The composition may notably comprise from 0% to 70%, in particular from 10% to 60%, more particularly from 20% to 50%, by weight of filler relative to the weight of the composition.

The composition according to the invention may comprise a reinforcement, more particularly a reinforcement chosen from plant fibres, glass fibres, carbon fibres, carbon nanotubes, polyester fibres, aramid fibres and mixtures thereof.

The composition may notably comprise from 0% to 70%, in particular from 10% to 60%, more particularly from 20% to 50%, by weight of reinforcement relative to the weight of the composition.

The composition according to the invention may comprise a tackifying resins; in particular an optionally modified rosin.

The composition according to the invention may further comprise a radical initiator. The radical initiator may notably make it possible to initiate the polymerization of component a).

The radical initiator may notably be a peroxide compound or an azo compound, in particular a peroxide.

An azo compound is a compound comprising an azo group of formula —N═N—. An example of a suitable azo compound is azobisisobutyronitrile (AIBN).

A peroxide compound is a compound comprising a peroxide group of formula —O—O—. A peroxide compound may notably be chosen from hydrogen peroxide, a hydroperoxide (R—O—O—H), a dialkyl or alkylaryl peroxide (R—O—O—R′), a peracid (RC(═O)—O—O—H), a peroxyester (RC(═O)—O—O—R′), a diacyl peroxide (RC(═O)—O—O—C(═O)—R′), a peroxycarbonate (R—O—C(═O)—O—O—C(═O)—O—R′), a peroxyketal (originating from the reaction between a ketone and hydrogen peroxide or a hydroperoxide), and also mixtures thereof, R and R′ independently being aliphatic, cycloaliphatic or aromatic groups. A peroxide compound may advantageously be in a stabilized form, notably in an aqueous phase, in a plasticiser or in an organic solvent.

Examples of suitable peroxides compounds are dibenzoyl peroxide, dilauroyl peroxide, diisopropyl peroxide, tert-butyl hydroperoxide, cumene hydroperoxide, cyclohexanone peroxide, methyl ethyl ketone peroxide, tert-butyl peroxyoctoate, tert-butyl peroxybenzoate, dicumyl peroxide, 1,1-bis(tert-butylperoxy)-3,3,5-trimethylcyclohexane, tert-butyl peroxymaleate and mixtures thereof.

In particular, the radical initiator may be benzoyl peroxide.

The composition may notably comprise an amount of radical initiator sufficient to obtain a complete polymerization of component a). In particular, the composition may comprise from 0.05% to 10%, from 0.1% to 5%, from 0.5% to 5% or from 0.5% to 3% by weight of radical initiator relative to the weight of component a).

The composition according to the invention may further comprise an activator of the radical initiator. A radical initiator activator may notably make it possible to activate the radical initiator at ambient temperature (20-25° C.) in order to initiate the polymerization of component a). The radical initiator activator may notably comprise a tertiary amine or a redox couple.

In order to prevent any premature polymerization of the composition according to the invention, the radical initiator may be brought into contact with component a) just before the application of the composition by the end user.

Thus, the present invention may also relate to a two-component system comprising:
a first cartridge comprising a radical initiator;
a second cartridge comprising the composition according to the invention and optionally an activator of the radical initiator;
the first cartridge being held separate from the second cartridge.

The containers of the first cartridge and of the second cartridge are intended to be brought into contact slightly before the application of the composition on a substrate.

The invention may also relate to a process for preparing a crosslinked product comprising the following steps:
mixing the composition according to the invention with a radical initiator and optionally an activator of the radical initiator in order to form a mixture;
applying the mixture obtained on a substrate.

The crosslinked product may notably be a coating, a moulding, a mastic, an adhesive, a liquid waterproofing system, a composite material, a chemical sealing system or a dental material.

The mixture may notably be applied on the surface of a substrate to be coated or to be waterproofed. Alternatively, the mixture may be applied on the surface of the substrate intended to be adhered to another substrate. Alternatively, the mixture may be applied so as to fill the void between two adjacent substrates or to fill the holes in the surface of a substrate. Alternatively, the mixture may be applied on a substrate comprising reinforcing fibres in order to form a composite material. Alternatively, the mixture may be applied to a substrate in the form of a mould.

The invention also relates to the use of an additive comprising a diurea-diurethane compound and containing less than 0.1 mol of salt per urea group in the additive (excluding any aprotic solvent) for increasing the viscosity and/or imparting thixotropic properties to a polymerizable component comprising a (meth)acrylate-functionalized compound. Said additive may notably correspond to component b) as described above for the composition according to the invention. The polymerizable component may notably correspond to component a) as described above for the composition according to the invention.

The invention is illustrated by the following non-limiting examples.

### Examples

### Starting Materials

TABLE 1

| Product used | Chemical name | Function | Supplier |
|---|---|---|---|
| MMA | methyl methacrylate | (meth)acrylate- | Arkema |
| | | functionalized monomer | |
| SR238 | 1,6-hexanediol | (meth)acrylate- | Arkema |
| | diacrylate | functionalized monomer | |
| SR351 | trimethylolpropane | (meth)acrylate- | Arkema |
| | triacrylate | functionalized monomer | |
| SR295 | pentaerythritol | (meth)acrylate- | Arkema |
| | tetraacrylate | functionalized monomer | |
| SR531 | cyclic | (meth)acrylate- | Arkema |
| | trimethylolpropane | functionalized monomer | |
| | formal acrylate | | |
| CN981 | difunctional aliphatic | (meth)acrylate- | Arkema |
| | urethane acrylate | functionalized oligomer | |
| | oligomer | | |
| Elium ® 190 | thermoplastic acrylic | (meth)acrylate- | Arkema |
| | resin | functionalized | |
| | | compound | |
| Omyacarb ® 10 AV | ground calcium | filler | OMYA |
| | carbonate | | |

### Thixotropic Additive 1 (TA 1) According to the Invention

Thixotropic additive 1 according to the invention is prepared as described in Example 8 of the patent application filed under the number PCT/EP2021/084323 (additive based on diurea-diurethane with no LiCl).

### Thixotropic Additive 2 (TA 2) According to the Invention

Thixotropic additive 2 according to the invention corresponds to the commercial product

Crayvallac® LA-377 available from Arkema (additive based on diurea-diurethane with no LiCl).

Comparative Thixotropic Additive C₁ (TA C₁)

Comparative thixotropic additive C₁ corresponds to the commercial product Crayvallac® LA-350 available from Arkema (additive based on diurea-diurethane containing more than 0.1 mol % of LiCl per urea group).

Comparative Thixotropic Additive C₂ (TA C₂)

Comparative thixotropic additive C₂ corresponds to the commercial product RHEOBYK® D-420 available from BYK (additive based on diurea-diurethane containing more than 0.1 mol % of LiCl per urea group).

### Preparation of the Compositions

### Composition Based on (Meth)Acrylate-Functionalized Monomer

The compositions were prepared in a 50 ml flask, using a high-speed disperser equipped with a deflocculator. The components, namely 1 g of thixotropic additive and 19 g of (meth)acrylate-functionalized monomer, were introduced into the flask. Next, the mixture was homogenized with stirring for 1 minute at 1000 rpm at 20° C. After this dispersion phase, the mixture was left at 20° C. without stirring for at least 10 min.

The components used to prepare the compositions are described in the table below (1% by weight of thixotropic additive relative to the weight of the composition):

TABLE 2

| | TA 1 | TA 2 | TA C1 | TA C2 | MMA | SR238 | SR351 | SR295 | SR531 |
|---|---|---|---|---|---|---|---|---|---|
| Example 1a | X | | | | X | | | | |
| Example 1b | X | | | | | X | | | |
| Example 1c | X | | | | | | X | | |
| Example 1d | X | | | | | | | | X |
| Example 2a | | X | | | X | | | | |
| Example 2b | | X | | | | X | | | |
| Example 2c | | X | | | | | X | | |
| Example 2d | | X | | | | | | X | |
| Example 2e | | X | | | | | | | X |
| Example C1a | | | X | | X | | | | |
| Example C1b | | | X | | | X | | | |
| Example C1c | | | X | | | | X | | |
| Example C1d | | | X | | | | | X | |
| Example C1e | | | X | | | | | | X |
| Example C2a | | | | X | X | | | | |
| Example C2b | | | | X | | X | | | |
| Example C2c | | | | X | | | X | | |
| Example C2d | | | | X | | | | X | |
| Example C2e | | | | X | | | | | X |

### Compositions Based on (Meth)Acrylate-Functionalized Monomer and (Meth)Acrylate-Functionalized Oligomer

The compositions were prepared in a 250 ml flask, using a high-speed disperser equipped with a deflocculator. The (meth)acrylate-functionalized compounds, namely 97.7 g of MMA and 2.3 g of CN981, were introduced and stirred at 20° C. until a homogeneous mixture is obtained. Next, the desired amount of thixotropic additive TA 2 was added to the flask. The mixture was then homogenized with stirring using a high-speed disperser equipped with a deflocculator for 5 minutes at 1500 rpm at 20° C. After this dispersion phase, the mixture was left at 20° C. without stirring for at least 10 min.

The amounts of thixotropic additive used to prepare the compositions are described in the table below (% by weight of thixotropic additive relative to the weight of the composition):

TABLE 3

| | % TA 2 |
|---|---|
| Example 3 | 1 |
| Example 4 | 2 |
| Example 5 | 9.8 |
| Example 6 | 16.8 |

### Compositions Based on a (Meth)Acrylate-Functionalized Compound

This series of compositions based on a (meth)acrylate-functionalized compound was prepared in a 50 ml flask according to a protocol similar to the one described for Examples 1a to C2e. The desired amounts of thixotropic additive TA2 and of resin Elium® 190 were introduced into the flask. Next, the mixture was homogenized with stirring using a high-speed disperser equipped with a deflocculator for 30 seconds at 800 rpm at 20° C. After this dispersion phase, the mixture was left at 20° C. without stirring for at least 10 min.

The amounts of thixotropic additive used to prepare the compositions are described in the table below (% by weight of thixotropic additive relative to the weight of the composition):

TABLE 4

| | % TA 2 |
|---|---|
| Example 7 | 0 |
| Example 8 | 0.125 |
| Example 9 | 0.25 |
| Example 10 | 0.5 |
| Example 11 | 1 |

### Compositions Based on (Meth)Acrylate-Functionalized Monomer and (Meth)Acrylate-Functionalized Oligomer and on a Filler

For these compositions, the mixture of (meth)acrylate-functionalized compounds was prepared beforehand, as follows: 97.7 g of MMA and 2.3 g of CN981 were introduced into a 250 ml flask and stirred at 20° C., using a high-speed disperser equipped with a deflocculator, until a homogeneous mixture is obtained. Next, the desired amount of Omyacarb® 10 AV filler was added and dispersed using the same high-speed disperser equipped with a deflocculator for 10 minutes at 2000 rpm. Next, in a 50 ml flask, the desired amounts of thixotropic additive TA 2 and of the previously prepared MMA/CN981/filler were introduced into the flask. The mixture was then homogenized with stirring using a high-speed disperser equipped with a deflocculator for 5 minutes at 1500 rpm at 20° C. After this dispersion phase, the mixture was left at 20° C. without stirring for at least 10 min.

The amounts of components used to prepare the compositions are described in the table below (% by weight relative to the weight of the composition):

TABLE 5

| | % MMA/CN981 | % Filler | % TA 2 |
|---|---|---|---|
| Example 12 | 50 | 50 | 0 |
| Example 13 | 49.5 | 49.5 | 1 |
| Example 14 | 49 | 49 | 2 |
| Example 15 | 48.5 | 48.5 | 3 |

### Characterization of the Compositions

### Visual Characterization

The performance of the thixotropic additive is evaluated by a visual characterization of the compositions, after having been left at 20° C. (without stirring) for 1 h, 24 h or 1 week.

An evaluation scale is defined as follows in order to allow the comparison of the samples.

TABLE 6
Gelation

| | |
|---|---|
| 0 | Incompatibility/heterogeneity |
| 1 | Liquid/absence of gel |
| 2 | Viscous liquid to fragile gel |
| 3 | Gel |

Turbidity

| | |
|---|---|
| T− | Cloudy |
| T | Translucent |
| T+ | Transparent |

Sedimentation

| | |
|---|---|
| S− | Significant sedimentation to heterogeneous |
| | system |
| S | Sedimentation |
| S+ | Very slight sedimentation to absence of |
| | sedimentation |

The visual evaluation of the compositions of Examples 1a to 11 is described in detail in the table below:

TABLE 7

| | 1 h | 1 h | 24 h | 24 h | 1 week | 1 week |
|---|---|---|---|---|---|---|
| | Gelation | Turbidity ® | Gelation | Turbidity | Gelation | Turbidity |
| Example 1a | 2 | T+ | 2 | T+ | 2 | T+ |
| Example 1b | 2 | T+ | 2 | T+ | 2 | T+ |
| Example 1c | 2 | T+ | 3 | T+ | 3 | T+ |
| Example 1d | 2 | T | 2 | T | 2 | T |
| Example 2a | 2 | T+ | 2 | T+ | 3 | T+ |
| Example 2b | 3 | T+ | 3 | T+ | 3 | T+ |
| Example 2c | 3 | T+ | 3 | T+ | 3 | T+ |
| Example 2d | 2 | T+ | 3 | T+ | 3 | T+ |
| Example 2e | 2 | T | 2 | T | 2 | T+ |
| Example C1a | 2 | T− | 2 | T− | 2 | T− |
| Example C1b | 0 | 0 | 0 | 0 | 0 | 0 |
| Example C1c | 0 | 0 | 0 | 0 | 0 | 0 |
| Example C1d | 2 | T− | 2 | T− | 3 | T− |
| Example C1e | 0 | 0 | 0 | 0 | 0 | 0 |
| Example C2a | 2 | T− | 2 | T− | 2 | T− |
| Example C2b | 2 | T− | 2 | T− | 2 | T− |
| Example C2c | 2 | T− | 2 | T− | 2 | T− |
| Example C2d | 2 | T− | 2 | T− | 3 | T− |
| Example C2e | 0 | 0 | 0 | 0 | 0 | 0 |
| Example 3 | 1 | T+ | 1 | T+ | 1 | T+ |
| Example 4 | 2 | T+ | 3 | T | 3 | T |
| Example 5 | 2 | T+ | 3 | T | 3 | T |
| Example 6 | 2 | T+ | 3 | T | 3 | T |
| Example 7 | 1 | T+ | 1 | T+ | 1 | T+ |
| Example 8 | 1 | T+ | 2 | T | 2 | T |
| Example 9 | 2 | T+ | 2 | T+ | 2 | T+ |
| Example 10 | 3 | T+ | 3 | T | 3 | T |
| Example 11 | 2 | T+ | 2 | T− | 2 | T− |

The visual evaluation of the compositions of Examples 12 to 15 is described in detail in the table below:

TABLE 8

| | 5 h | 5 h | 24 h | 24 h | 1 week | 1 week |
|---|---|---|---|---|---|---|
| | Gelation | Sedimentation | Gelation | Sedimentation | Gelation | Sedimentation |
| Example 12 | 0 | S− | 0 | S− | 0 | S− |
| Example 13 | 0 | S− | 0 | S− | 0 | S− |
| Example 14 | 3 | S+ | 3 | S+ | 3 | S+ |
| Example 15 | 3 | S+ | 3 | S+ | 3 | S+ |

### Viscosity Measurement

The viscosity measurements were performed in accordance with standard NF EN ISO 2555 using a Brookfield® viscometer at 22° C. (spindle: S63). A spindle of cylindrical shape rotates at a constant rotational speed around its axis in the product to be examined. The resistance which is exerted by the fluid on the spindle depends on the viscosity of the product. This resistance brings about torsion of the spiral spring, which is reflected in a viscosity value.

The viscosity of the compositions of Examples 7 to 11 measured at 22° C., after 24 h is described in detail in the table below:

TABLE 9

| | Viscosity (mPa · s) | | |
|---|---|---|---|
| | 5 rpm | 50 rpm | 5/50 thixo index* |
| Example 7 | 156 | 117 | 1.3 |
| Example 8 | 312 | 168 | 1.9 |
| Example 9 | 564 | 247 | 2.3 |
| Example 10 | 1464 | 547 | 2.7 |
| Example 11 | 3076 | 1000 | 3.1 |

*The 5/50 thixo index corresponds to the ratio of the viscosity at 5 rpm to the viscosity at 50 rpm

The viscosity of the compositions of Examples 12 and 14 measured at 22° C., after a week is described in detail in the table below:

TABLE 10

| | Viscosity (mPa · s) | | |
|---|---|---|---|
| | 1 rpm | 10 rpm | 100 rpm |
| Example 12 | 90 | 10 | 10 |
| Example 14 | 3140 | 1100 | 1100 |

1. A composition comprising:
a) a polymerizable component comprising a (meth)acrylate-functionalized compound; and
b) a thixotropic additive comprising a diurea-diurethane compound;
characterized in that component b) contains less than 0.1 mol of salt per urea group in component b) (excluding any aprotic solvent).

2. The composition according to claim 1, characterized in that component a) comprises a (meth)acrylate-functionalized compound chosen from a (meth)acrylate-functionalized monomer, a (meth)acrylate-functionalized oligomer, and mixtures thereof.

3. The composition according to claim 1, characterized in that component a) comprises a mono(meth)acrylate-functionalized monomer chosen from (meth)acrylic acid; methyl(meth)acrylate; ethyl(meth)acrylate; n-propyl(meth)acrylate; isopropyl(meth)acrylate; n-butyl(meth)acrylate; isobutyl(meth)acrylate; n-pentyl(meth)acrylate; n-hexyl(meth)acrylate; 2-ethylhexyl(meth)acrylate; n-octyl(meth)acrylate; isooctyl(meth)acrylate; n-decyl(meth)acrylate; isodecyl(meth)acrylate; n-dodecyl(meth)acrylate; tridecyl(meth)acrylate; tetradecyl(meth)acrylate; hexadecyl(meth)acrylate; 2-hydroxyethyl(meth)acrylate; 2-hydroxypropyl(meth)acrylate; 3-hydroxypropyl(meth)acrylate; 4-hydroxybutyl(meth)acrylate; 2-methoxyethyl(meth)acrylate; 2-ethoxyethyl(meth)acrylate; 2-ethoxypropyl(meth)acrylate; 3-ethoxypropyl(meth)acrylate; tetrahydrofurfuryl(meth)acrylate; 2-(2-ethoxyethoxy)ethyl(meth)acrylate; cyclohexyl(meth)acrylate; glycidyl(meth)acrylate; benzyl(meth)acrylate; 2-phenoxyethyl(meth)acrylate; phenol (meth)acrylate; nonylphenol (meth)acrylate; cyclic trimethylolpropane formal (meth)acrylate; isobornyl(meth)acrylate; tricyclodecane methanol (meth)acrylate; tert-butylcyclohexyl(meth)acrylate; trimethylcyclohexyl(meth)acrylate; diethylene glycol monomethyl ether (meth)acrylate; diethylene glycol monobutyl ether (meth)acrylate; triethylene glycol monoethyl ether (meth)acrylate; polyethylene glycol monomethyl ether (meth)acrylate; hydroxyl ethyl-butyl urethane (meth)acrylate; 3-(2-hydroxyalkyl) oxazolidinone (meth)acrylate; (2,2-dimethyl-1,3-dioxolan-4-yl)methyl(meth)acrylate; (2-ethyl-2-methyl-1,3-dioxolan-4-yl)methyl(meth)acrylate; 1,3-dioxan-5-yl(meth)acrylate; (1,3-dioxolan-4-yl)methyl(meth)acrylate; glycerol carbonate (meth)acrylate; the alkoxylated derivatives thereof; and mixtures thereof.

4. (canceled)

5. The composition according to claim 1, characterized in that component a) comprises methyl methacrylate optionally as a mixture with at least one other (meth)acrylate-functionalized compound.

6. The composition according to claim 1, characterized in that component a) comprises a poly(meth)acrylate-functionalized monomer chosen from bisphenol A di(meth)acrylate; hydrogenated bisphenol A di(meth)acrylate; ethylene glycol di(meth)acrylate; diethylene glycol di(meth)acrylate; triethylene glycol di(meth)acrylate; tetraethylene glycol di(meth)acrylate; polyethylene glycol di(meth)acrylate; propylene glycol di(meth)acrylate; dipropylene glycol di(meth)acrylate; tripropylene glycol di(meth)acrylate; tetrapropylene glycol di(meth)acrylate; polypropylene glycol di(meth)acrylate; polytetramethylene glycol di(meth)acrylate; 1,2-butanediol di(meth)acrylate; 2,3-butanediol di(meth)acrylate; 1,3-butanediol di(meth)acrylate; 1,4-butanediol di(meth)acrylate; 1,5-pentanediol di(meth)acrylate; 1,6-hexanediol di(meth)acrylate; 1,8-octanediol di(meth)acrylate; 1,9-nonanediol di(meth)acrylate; 1,10-decanediol di(meth)acrylate 1,12-dodecanediol di(meth)acrylate; neopentyl glycol di(meth)acrylate; 2-methyl-2,4-pentanediol di(meth)acrylate; polybutadiene di(meth)acrylate; cyclohexane-1,4-dimethanol di(meth)acrylate; tricyclodecane dimethanol di(meth)acrylate; glycerol di(meth)acrylate; glycerol tri (meth)acrylate; trimethylolethane tri (meth)acrylate; trimethylolethane di(meth)acrylate; trimethylolpropane tri (meth)acrylate; trimethylolpropane di(meth)acrylate; pentaerythritol di(meth)acrylate; pentaerythritol tri (meth)acrylate, pentaerythritol tetra(meth)acrylate, di(trimethylolpropane) di(meth)acrylate; di(trimethylolpropane) tri (meth)acrylate; di(trimethylolpropane) tetra(meth)acrylate; sorbitol penta (meth)acrylate; di(pentaerythritol) tetra(meth)acrylate; di(pentaerythritol) penta (meth)acrylate; di(pentaerythritol) hexa (meth)acrylate; tris(2-hydroxyethyl) isocyanurate tri (meth)acrylate; and also the alkoxylated (e.g. ethoxylated and/or propoxylated) derivatives thereof; and the mixtures thereof.

7. (canceled)

8. The composition according to claim 1, characterized in that component a) comprises a (meth)acrylate-functionalized oligomer chosen from (meth)acrylate-functionalized urethane oligomers, (meth)acrylate-functionalized epoxy oligomers, (meth)acrylate-functionalized polyether oligomers, (meth)acrylate-functionalized polydiene oligomers, (meth)acrylate-functionalized polycarbonate oligomers, (meth)acrylate-functionalized polyester oligomers; (meth)acrylate-functionalized acrylic oligomers; and mixtures thereof.

9. (canceled)

10. The composition according to claim 1, characterized in that component a) comprises:
from 10% to 100%, by weight of (meth)acrylate-functionalized monomer; and
from 0% to 90% by weight of (meth)acrylate-functionalized oligomer.

11. The composition according to claim 1, characterized in that component b) comprises a diurea-diurethane compound of formula (I) or a mixture of diurea-diurethane compounds of formula (I): 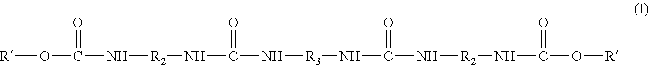
wherein
each R′ is independently chosen from alkyl, alkenyl, cycloalkyl, aryl, arylalkyl, •—[(CRₐR_{b})ₙ—O]ₘ—
Y and •—[(CR_{c}R_{d})ₚ—C(═O)O]_{q}—Z;
the symbol • represents a point of attachment to a urethane group of the formula (I);
each R₂ is independently a divalent group chosen from an aliphatic group, a cycloaliphatic group, an aromatic group and an araliphatic group;
each R₃ is independently a divalent group chosen from an aliphatic group, a cycloaliphatic group, an aromatic group, an araliphatic group and a heterocyclic group;
Y and Z are independently chosen from alkyl, alkenyl, cycloalkyl, aryl and arylalkyl;
Rₐ, R_{b}, R_{c} and R_{d} are independently chosen from H and methyl;
each n is independently equal to 2, 3 or 4;
m ranges from 1 to 30;
p ranges from 3 to 5;
q ranges from 1 to 20.

12. The composition according to claim 1, characterized in that component b) contains from 0 to less than 0.1 mol, or from 0 to 0.09 mol, or from 0 to 0.07 mol, or from 0 to 0.05 mol, or from 0 to 0.03 mol, or from 0 to 0.02 mol, or from 0 to 0.01 mol, of salt per urea group in component b).

13. The composition according to claim 1, characterized in that the salt of component b) is chosen from a metal salt, an ionic liquid and an ammonium salt.

14. The composition according to claim 1, characterized in that component b) contains less than 0.1 mol of surfactant per urea group in component b).

15. The composition according to claim 1, characterized in that the NCO index of component b) is less than 0.5 mg KOH/g.

16. The composition according to claim 1, characterized in that component b) comprises 5 to 80 mol % of diurea-diurethane compound relative to the total molar amount of compounds having one or more functions chosen from urea, urethane and mixtures thereof.

17. The composition according to claim 1, characterized in that component b) further comprises at least one diurethane compound of formula (II): 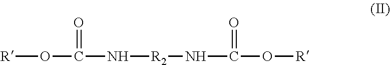
wherein
each R′ is independently chosen from alkyl, alkenyl, cycloalkyl, aryl, arylalkyl, •—[(CRₐR_{b})ₙ—O]ₘ—
Y and •—[(CR(Rₐ)ₚ—C(═O)O]_{q}—Z;
the symbol • represents a point of attachment to a urethane group of the formula (I);
each R₂ is independently a divalent group chosen from an aliphatic group, a cycloaliphatic group,
an aromatic group and an araliphatic group;
Y and Z are independently chosen from alkyl, alkenyl, cycloalkyl, aryl and arylalkyl;
Rₐ, R_{b}, R_{c} and Rₐ are independently chosen from H and methyl;
each n is independently equal to 2, 3 or 4;
m ranges from 1 to 30;
p ranges from 3 to 5;
q ranges from 1 to 20.

18. The composition-according to claim 17, characterized in that component b) comprises 20 to 95 mol % of diurethane compound of formula (II) relative to the total molar amount of compounds having one or more functions chosen from urea, urethane and mixtures thereof, excluding any aprotic solvent.

19. The composition according to claim 11, characterized in that each R′ is independently chosen from alkyl and •—•—[CRₐR_{b})ₙ—O]ₘ—Y;
and m ranges from 2 to 20.

20. The composition according to claim 11, characterized in that each R₂ is independently an aromatic group.

21. The composition according to claim 11, characterized in that more than 85 mol % of all of the R₂ groups contained in the diurea-diurethane compound(s) of formula (I) are aromatic groups of the following formula: 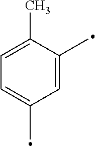
in which the symbol • represents a point of attachment to a urea or urethane group of the formula (I).

22. The composition according to claim 11, characterized in that each R₃ is independently a group chosen from C₂-C₂₄ alkylene,
(CRₕRᵢ)ₛ—[A—(CRⱼRₖ)ₜ]ᵤ— and
(CRₗRₘ)ᵥ—CY—(CRₙRₒ)_{w}— and —(CRₚR_{q})ₓ—CY—(CH₂) γ—CY—(CRₗRₘ)_{z}—;
in which:
A is O or NX;
Rₕ, Rᵢ, Rⱼ, Rₖ, R₁, Rₘ, Rₙ, Rₒ, Rₚ, R_{q}, Rᵣ and R₅ are independently chosen from H and methyl;
X is a C₁ to C₆ alkyl;
CY is a ring chosen from phenyl, cyclohexyl, naphthyl, decahydronaphthyl, piperazinyl, triazinyl and pyridinyl, the ring being unsubstituted or substituted by 1 to 3 C₁-C₄ alkyl groups;
s ranges from 2 to 4;
t ranges from 2 to 4;
u ranges from 1 to 30;
v, W, x, y and z independently range from 0 to 4.

23. (canceled)

24. The composition according to claim 11, characterized in that component b) is obtained by a process comprising the following steps:
a) reacting at least one diisocyanate of formula OCN—R₂—NCO with at least one alcohol of formula R′—OH in order to form at least one monoisocyanate adduct of formula R′—O—C(═O)—NH—R₂—NCO, the molar ratio of the total amount of alcohol to the total amount of diisocyanate ranging from 1.10 to 1.80;
b) reacting the at least one monoisocyanate adduct obtained in step a) with at least one diamine of formula H₂N—R₃—NH₂ in the presence of less than 0.2 mol of metal salt per mole of diamine used, in order to form at least one diurea-diurethane compound of formula (I)

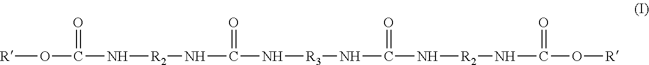

25. The composition according to claim 24, characterized in that step b) is carried out in the presence of from 0 to 0.19 mol of salt per mole of diamine used.

26. The composition according to claim 24, characterized in that step b) is carried out in the presence of less than 0.2 mol of surfactant per mole of diamine used.

27. The composition according to claim 24, characterized in that it does not comprise a step of distillation of residual diisocyanate.

28. The composition according to claim 24, characterized in that the amount of residual diisocyanate in the reaction mixture at the end of step a) is less than 6 mol % relative to the molar amount of all of the compounds having one or more functions chosen from urethane and isocyanate.

29. The composition according to claim 24, characterized in that step a) and/or step b) is carried out in the presence of an aprotic solvent.

30. The composition according to claim 1, characterized in that component b) further comprises an aprotic solvent chosen from dimethyl sulfoxide, N,N-dimethylformamide, N,N-dimethylacetamide, N-methylpyrrolidone, N-ethylpyrrolidone, N—propylpyrrolidone, N-butylpyrrolidone, N,N,N′,N′-tetramethylurea and mixtures thereof.

31. The composition according to claim 1, characterized in that component b) further comprises 20% to 95% by weight of an aprotic solvent, relative to the weight of component b).

32. The composition according to claim 1, characterized in that said composition comprises from 0.05% to 50% by weight component b) relative to the weight of the composition.

33. The composition according to claim 1, characterized in that said composition is a coating composition, a moulding composition, a mastic composition, an adhesive composition, a liquid waterproofing composition, a composite material composition, a chemical sealing composition or a dental material composition.

34. The composition according to claim 1, characterized in that said composition further comprises a filler, a reinforcer, a tackifying resin or a radical initiator.

35. (canceled)

36. (canceled)

37. (canceled)

38. The composition according to claim 37, characterized in that said composition comprises the radical initiator and further comprises an activator of the radical initiator.

39. A two-component system, characterized in that it comprises:
a first cartridge comprising a radical initiator;
a second cartridge comprising the composition according to claim 1;
the first cartridge being held separate from the second cartridge.

40. A process for preparing a crosslinked product comprising the following steps:
mixing the composition according to claim 1 with a radical initiator and optionally an activator of the radical initiator;
applying the mixture obtained on a substrate.

41. (canceled)
